(19) United States
(12) Patent Application Publication
(10) Pub. No.: US 2015/0248432 A1
(43) Pub. Date: Sep. 3, 2015

(54) METHOD AND SYSTEM

(71) Applicant: FUJITSU LIMITED, Kawasaki-shi (JP)

(72) Inventors: Masahiro Kataoka, Tama (JP); Yasuhiro Suzuki, Yokohama (JP); KOHSHI YAMAMOTO, Kawasaki (JP)

(73) Assignee: FUJITSU LIMITED, Kawasaki (JP)

(21) Appl. No.: 14/714,751

(22) Filed: May 18, 2015

Related U.S. Application Data
(63) Continuation of application No. PCT/JP2012/008114, filed on Dec. 19, 2012.

(51) Int. Cl. G06F 17/30

(52) U.S. Cl. CPC G06F 17/30153; G06F 17/30371

(57) ABSTRACT

A method includes: acquiring a data string including a data group of which the sizes of constituent units of data are different sizes; executing a comparing process, the comparing process comparing certain data included in the data group with data that is included in the data string and of which the sizes of constituent units are the same as the certain data; extracting data matching the certain data from the data string based on the comparing process; and generating, by a processor, a compressed code based on a relationship between a position of the certain data in the data string and a position of the extracted matching data in the data string.

### CROSS-REFERENCE TO RELATED APPLICATION

This application is a continuation application of International Application PCT/JP2012/008114 filed on Dec. 19, 2012 and designated the U.S., the entire contents of which are incorporated herein by reference.

### FIELD

The embodiment discussed herein is related to a technique for compressing or decompressing data.

### BACKGROUND

A compression algorithm that is referred to as LZ77 is known. In LZ77, a compressed code is generated based on the position and length of certain data that appears before data to be processed and is the same as the data to be processed. The certain data that appears before the data to be processed and is the same as the data to be processed is searched by a process of comparing the data to be processed with the certain data that appears before the data to be processed. In the comparing process, the data to be processed is compared with the certain data on a predetermined data unit basis. For example, if the predetermined data unit is 1 byte, the process of comparing the data to be processed with the certain data that appears before the data to be processed is executed on a byte basis.

As an example of related art, Japanese Laid-open Patent Publication No. 8-234959 is known.

### SUMMARY

According to an aspect of the invention, a method includes: acquiring a data string including a data group of which the sizes of constituent units of data are different sizes; executing a comparing process, the comparing process comparing certain data included in the data group with data that is included in the data string and of which the sizes of constituent units are the same as the certain data; extracting data matching the certain data from the data string based on the comparing process; and generating, by a processor, a compressed code based on a relationship between a position of the certain data in the data string and a position of the extracted matching data in the data string.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the flow of a compression process using LZ77;

FIG. 2 illustrates the flow of a decompression process using LZ77;

FIG. 3 illustrates the assignment of UTF-8 codes;

FIG. 4 illustrates an example of the compression process;

FIG. 5 illustrates an example of an encoding dictionary;

FIG. 6 illustrates an example of an another encoding dictionary;

FIG. 7 illustrates an example of the decompression process;

FIG. 8 illustrates an example of a functional configuration;

FIG. 9 illustrates an example of a positional information table;

FIG. 10 illustrates an example of a procedure for the compression process;

FIG. 11 illustrates an example of a procedure for a process of searching the longest matching fixed-length code string;

FIG. 12 illustrates an example of a procedure for a process of acquiring a fixed-length code;

FIG. 13 illustrates an example of a process of generating and writing compressed data;

FIG. 14 illustrates an example of a procedure for a process of updating a storage region;

FIG. 15 illustrates an example of a procedure for a process of updating another storage region;

FIG. 16 illustrates an example of another positional information table;

FIG. 17 illustrates an example of a procedure for the decompression process;

FIG. 18 illustrates an example of a procedure for a process of updating another storage region;

FIG. 19 illustrates an example of a hardware configuration of a computer;

FIG. 20 illustrates an example of a configuration of programs that are executed on the computer;

FIG. 21 illustrates an example of a configuration of devices included in a system according to an embodiment;

FIG. 22 illustrates an example of a comparing process to be executed on each data unit different from data units forming data to be compressed;

FIG. 23 illustrates an example of a comparing process to be executed on each data unit different from data units forming data to be compressed;

FIG. 24 illustrates an example of processes of S301 to S303;

FIG. 25 illustrates an example of an index of the encoding dictionary;

FIG. 26 illustrates a modified example of a process of searching the longest matching code string; and

FIG. 27 illustrates an example of a procedure for the process of searching the longest matching code string.

### DESCRIPTION OF EMBODIMENT

The lengths of data units that form data to be compressed may not be a fixed value. In document data, a character set that uses multiple different numbers of bytes each representing a single character exists, for example. According to UTF-8 or the like, characters (for example, alphanumeric characters and the like) each represented by 1 byte, characters (for example, a part of first-level kanji characters, second-level kanji characters, kana characters, and the like) each represented by 3 bytes, and characters (for example, a part of third-level kanji characters, a part of fourth-level kanji characters, and the like) each represented by 4 bytes exist. According to related art, a process of comparing data that is to be compressed according to UTF-8 or the like and includes multiple types of data units is executed on each data unit (of, for example, 1 byte) different from the actual data units (of, for example, multiple bytes) forming the data to be compressed.

An object of an aspect of an embodiment is to improve an efficiency of a process of comparing data formed by data units of multiple types in a compression process.

According to the aspect of the embodiment, in the compression process, the execution of the comparing process on each data unit different from the data units forming the data to be compressed is suppressed.

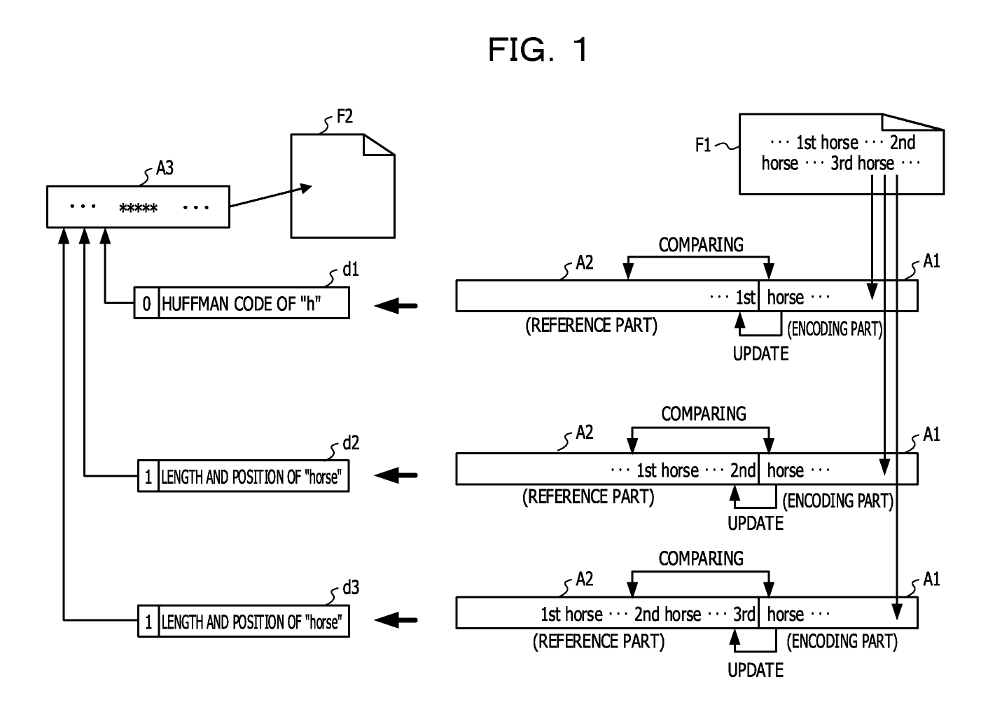

FIG. 1 illustrates the flow of the compression process using LZ77. First, a storage region A1, a storage region A2, and a storage region A3 are secured in a memory, for example. Data of a content part included in a file F1 illustrated in FIG. 1 is loaded into the storage region A1. The storage region A1 is referred to as an encoding part or the like, for example. The first F1 includes data “ . . . 1st horse . . . 2nd horse . . . 3rd horse . . . ” (a symbol “ . . . ” is an unspecified character string). A process (described later) of generating compressed data is executed based on the data loaded in the storage region A1. In addition, the data used for the process of generating the compressed data is copied from the storage region A1 to the storage region A2. The storage region A2 is referred to as a reference part, for example. The compressed data is generated based on the results of a process of comparing the data loaded in the storage region A1 with the data within the storage region A2. The generated compressed data is sequentially stored in the storage region A3. A compressed file F2 is generated based on the compressed data stored in the storage region A3. FIG. 1 schematically illustrates the data within the storage regions A1 and A2.

The generation of compressed data d1 is described using an example in which “h” and subsequent characters of data “1st horse . . . ” illustrated in FIG. 1 are data to be processed. First, the longest matching data of “horse . . . ” is searched within the storage region A2 (“comparing” illustrated in FIG. 1). In the example illustrated in FIG. 1, data that matches the top data “h” of the data to be processed does not exist in the storage region A2. If data that matches the data to be processed does not exist in the storage region A2, the compressed data d1, which includes a Huffman code obtained by encoding, by a Huffman encoding and decoding algorithm, the top data of the data to be processed, is generated. Huffman encoding that is executed to generate the compressed data is an example. Another compression algorithm may be used, or uncompressed data that is the top data may be used. The compressed data d1 includes an identifier (“0” in the example illustrated in FIG. 1) representing that the compressed data d1 is not data compressed based on the longest matching data.

The generation of compressed data d2 is described using an example in which “h” and subsequent characters of data “2nd horse . . . ” illustrated in FIG. 1 are data to be processed. First, the longest matching data of “horse . . . ” is searched within the storage region A2 (“comparing” illustrated in FIG. 1). In the example illustrated in FIG. 1, since “1st horse . . . ” exists in the storage region A2, “horse” of the data to be processed matches “horse” of “1st horse . . . ” within the storage region A2, for example. For example, if the matching data “horse” within the storage region A2 is the longest data (longest matching data) matching the data that is stored in the storage region A2 and to be processed, the compressed data d2 is generated based on the position of the longest matching data within the storage region A2 and the length of the longest matching data. The compressed data d2 includes an identifier (“1” in the example illustrated in FIG. 1) representing that the compressed data d2 is data compressed based on the longest matching data.

The generation of compressed data d3 is described using an example in which “h” and subsequent characters of data “3rd horse . . . ” illustrated in FIG. 1 are data to be processed. First, the longest matching data of “horse . . . ” is searched within the storage region A2 (“comparing” illustrated in FIG. 1). In the example illustrated in FIG. 1, “1st horse . . . 2nd horse . . . ” exists in the storage region A2, and “horse” of the data to be processed matches “horse” of “1st horse” and “2nd horse” within the storage region A2, for example. For example, if “horse” of “1st horse” or “2nd horse” within the storage region A2 is the longest matching data, the compressed data d3 is generated based on the position of the longest matching data within the storage region A2 and the length of the longest matching data. The compressed data d3 includes an identifier (“1” in the example illustrated in FIG. 1) representing that the compressed data d3 is data compressed based on the longest matching data.

The generated compressed data d1 to d3 is stored in the storage region A3 and included in the compressed file F2 by a process of generating the compressed file F2.

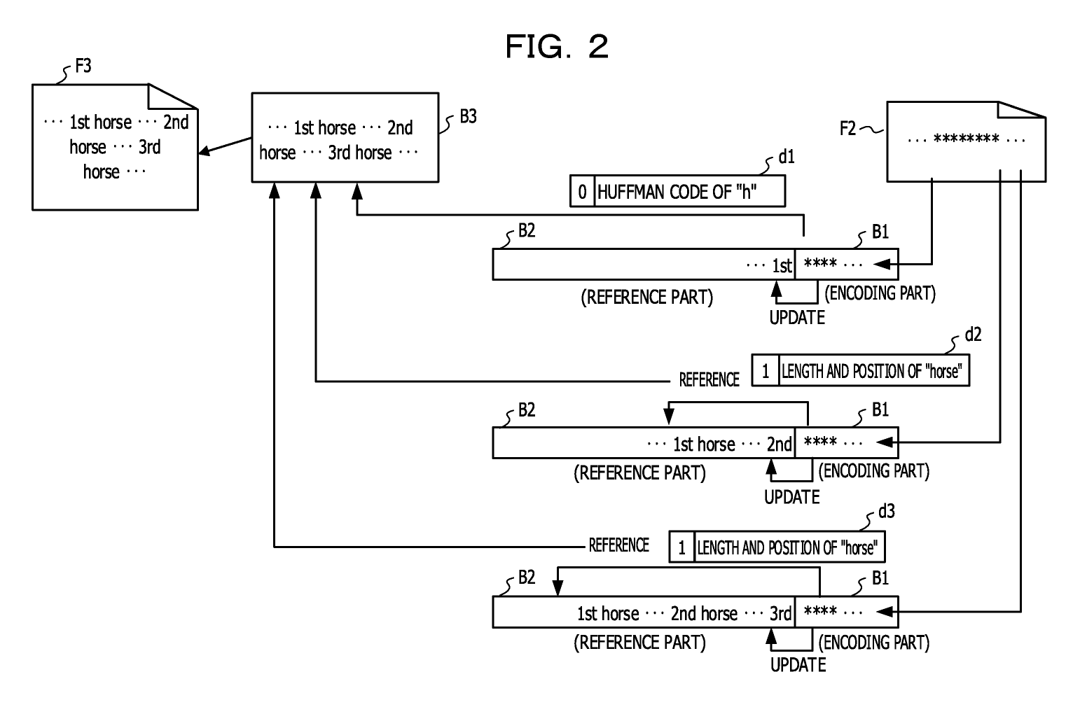

FIG. 2 illustrates the flow of a decompression process using LZ77. In the decompression process, compressed data within the compressed file F2 is loaded into a memory (storage region B1), and a process of generating decompressed data is executed based on an identifier of the loaded compressed data. A symbol “*” illustrated in FIG. 2 represents compressed data. The storage region B1 is referred to as an encoding part or the like, for example. If compressed data (compressed data d1 illustrated in FIG. 2 or the like) that includes an identifier (“0” in the example illustrated in FIG. 1) representing that the compressed data is not data compressed based on the longest matching data is read, decompressed data is generated by a decoding process executed in accordance with the Huffman encoding and decoding algorithm. The generated decompressed data is stored in a storage region B2 and a storage region B3. The storage region B2 is referred to as a reference part or the like, for example.

On the other hand, if compressed data (compressed data d2 and d3 illustrated in FIG. 2 or the like) that includes an identifier (“1” in the example illustrated in FIG. 1) representing that the compressed data is data compressed based on the longest matching data is read, data that is represented by a compressed code and stored in the storage region B2 is decompressed data corresponding to the compressed data. If the identifier represents that the compressed data is data compressed based on the longest matching data, the generated decompressed data is stored in the storage region B2 and the storage region B3.

By storing the decompressed data in the storage region B2, the storage region B2 may be in the same state as the storage region A2 upon a process of generating a compressed code. Thus, data that is the same as data before compression executed based on the compressed code is acquired. A decompressed file F3 is generated based on the decompressed data stored in the storage region B3.

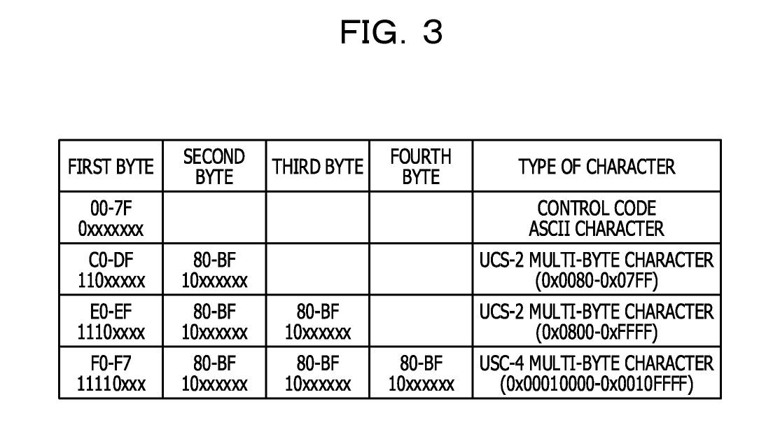

FIG. 3 illustrates the assignment of UTF-8 codes. According to UTF-8, character codes of 1 to 4 bytes are used, as described above. Ranges of values of the character codes are defined based on the lengths of the character codes.

A character code of 1 byte is represented by any of values of 0x00 to 0x7F. The character code of 1 byte is “0XXXXXXX” in binary notation, and the top bit of the character code is “0” (“X” is a value of “0” or “1”). The first byte of a character code of 2 bytes is any of values of 0xC2 to 0xDF (0xC0 and 0xC1 are used for control codes, for example), and the second byte of the character code of 2 bytes is any of values of 0x80 to 0xBF. Specifically, in the character code of 2 bytes, the first byte is “110YYYYX” and the second byte is “10XXXXXX” (“Y” represents that at least one of continuous characters “Y” is 1). The first byte of a character code of 3 bytes is any of values of 0xE0 to 0xEF, and the second and third bytes of the character code of 3 bytes are each any of values of 0x80 to 0xBF. Specifically, in the character code of 3 bytes, the first byte is “1110YYYY”, the second byte is “10YXXXXX”, and the third byte is “10XXXXXX”. The first byte of a character code of 4 bytes is any of values of 0xF0 to 0xF7, and the second to fourth bytes of the character code of 4 bytes are each any of values of 0x80 to 0xBF. Specifically, in the character code of 4 bytes, the first byte is “11110YYY”, the second byte is “10YYXXXX”, and the third and fourth bytes are “10XXXXXX”.

In the assignment of UTF-8 codes, data of the first byte of a character code of 2 bytes or more is different from data of the second and subsequent bytes of the character code of 2 bytes or more. In the compression process described with reference to FIG. 1, data of the first byte of a character code of 3 bytes within the storage region A1 is compared with data within the storage region A2, for example. In the storage region A2, data of the second byte of the character code of 3 bytes and data of the third byte of the character code of 3 bytes are included. In a conventional technique, in a character set such as UTF-8 in which data of the first byte of a character code of 2 bytes or more has a value different from data of the second byte or the second and subsequent bytes of the character code, a process of comparing the data of the first byte with the data of the second byte or the second and subsequent bytes is executed, regardless of the fact that it is apparent that the value of the first byte is different from a value of the second byte or values of the second and subsequent bytes.

Compression (for example, compression using ZIP or the like) using LZ77 may be applicable to data from which the results of comparing data to be compressed are obtained. ZIP or the like is used for data of different types, such as document data and image data, for general purposes, for example. Since the compression is applicable to data of different types, it has been difficult to make an improvement for data of a specific type. However, by monitoring a detailed procedure for the process of comparing data in a specific character set, the inventors clarified, upon consideration, that the comparing process was executed between data with a certain value and data with a value different from the certain value, regardless of the difference between the values, as described above.

As described above, since the comparing process is executed on each data unit smaller than data units of character codes, unwanted comparing may be executed. In the embodiment, data that uses a character set that is UTF-8 or the like and used for character codes of multiple different sizes is managed based on data units associated with the character codes, and comparing is executed based on each of the managed data units.

In addition, compression encoding is executed on different 3-byte characters while ignoring boundaries of the character codes. For example, 0xE2BC98E386 (5 bytes) is extracted as a matching data string by comparing “+−” (0xE2BC98E38692) with “+=” (0xE2BC98E386), and a compressed code is assigned to the matching data string. In this case, a remaining part (0x92 of “+−”) of the character code is to be compared, and the comparing process is executed while the remaining part is shifted from a boundary of the character code (or the data is separated from the boundary). Thus, a reduction in a compression rate may be expected.

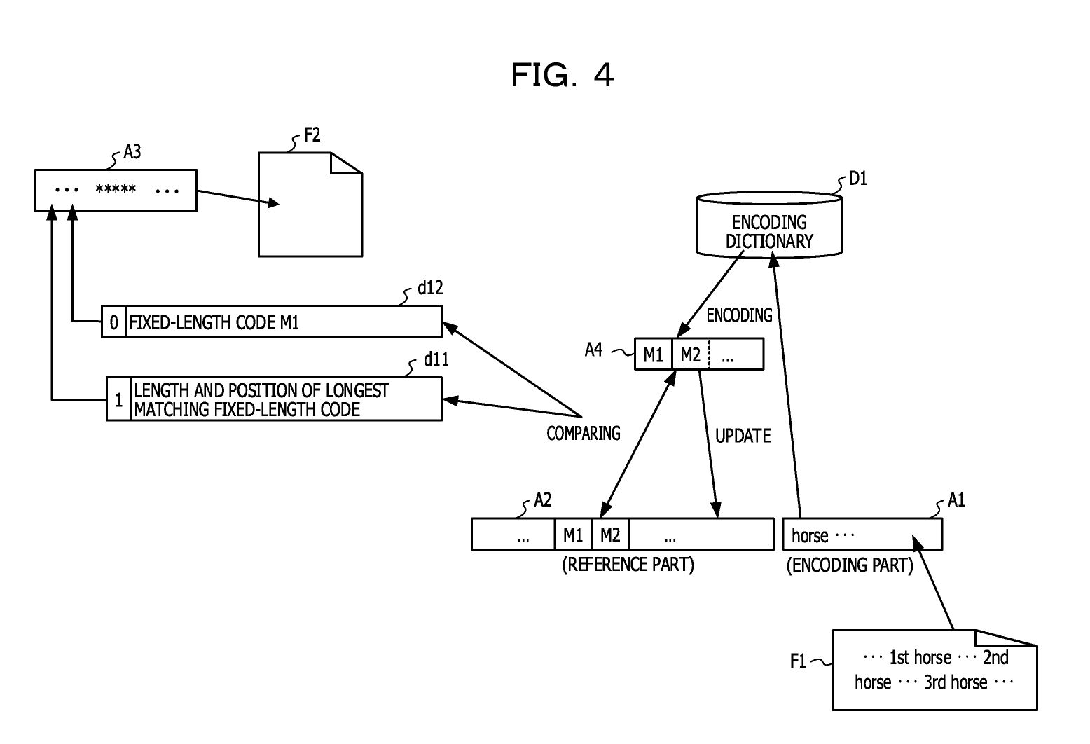

FIG. 4 illustrates an example of the compression process. First, the storage region A1, the storage region A2, the storage region A3, and the storage region A4 are secured in the memory. The data of the content part included in the file F1 illustrated in FIG. 4 is loaded into the storage region A1. The storage region A1 is referred to as the encoding part or the like, for example. The file F1 includes data “ . . . 1st horse . . . 2nd horse . . . 3rd horse . . . ” (“ . . . ” represents an unspecified character string).

The data loaded in the storage region A1 is converted into a fixed-length code based on an encoding dictionary D1. A process of generating compressed data is executed based on the fixed-length code obtained by the conversion. In addition, the fixed-length code used for the generation of the compressed data is stored in the storage region A2. The storage region A2 is referred to as the reference part, for example. The compressed data is generated based on the results of the process of comparing the fixed-length code obtained by the conversion with the fixed-length code stored in the storage region A2. The generated compressed data is sequentially stored in the storage region A3, and the compressed file F2 is generated based on the compressed data stored in the storage region A3. FIG. 4 schematically illustrates the data within the storage regions A1 and A2.

In the example illustrated in FIG. 4, a character code L1 is read from the storage region A1, and a fixed-length code M1 associated with the read character code L1 is read from the encoding dictionary D1. The read fixed-length code M1 is stored in the storage region A4. The comparing process is executed sequentially on fixed-length codes stored in the storage region A2 based on the fixed-length code M1 stored in the storage region A4. If a fixed-length code N1 that matches the fixed-length code M1 stored in the storage region A4 exists in the storage region A2, a character code L2 is read from the storage region A1 and a fixed-length code M2 associated with the read character code L2 is read from the encoding dictionary D1 and stored in the storage region A4. In addition, whether or not a fixed-length code N2 that succeeds the fixed-length code N1 within the storage region A2 matches the fixed-length code M2 is determined. If the fixed-length code N2 matches the fixed-length code M2, a character code is read from the storage region A1 and the same procedure as described above is repeated. The aforementioned procedure is repeated until an unmatched fixed-length code is obtained or the number of continuously matching fixed-length codes exceeds a lower limit (for example, a predetermined number of codes) Lmin. The same process is executed on the overall storage region A2, and a string (longest matching fixed-length code string) of the longest matching fixed-length codes is extracted from the storage region A2.

If the length of the longest matching fixed-length code string is equal to or larger than the lower limit Lmin, compressed data d11 is generated. The compressed data d11 includes an identifier (“1” in the example illustrated in FIG. 4) representing that the compressed data d11 is a code compressed based on the longest matching fixed-length code string. The compressed data d11 also includes a compressed code representing the length (for example, the number of the fixed-length codes included in the longest matching fixed-length code string) of the longest matching fixed-length code string and the position of the longest matching fixed-length code string. The position of the longest matching fixed-length code string is represented by the number of fixed-length codes that represents a position separated by the number of the codes from an update position of the storage region A2 or the like. In addition, a fixed-length code string stored in the storage region A4 is written in the storage region A2. If fixed-length codes are written in the overall storage region A2, the fixed-length code string stored in the storage region A4 is written over a fixed-length code that has been first written in the storage region A2 among the fixed-length codes stored in the storage region A2.

If the length of the longest matching fixed-length code string is smaller than the lower limit Lmin, compressed data d12 is generated. The compressed data d12 includes the fixed-length code M1 and an identifier (“0” in the example illustrated in FIG. 4) representing that the compressed data d12 is not a code compressed based on the longest matching fixed-length code string. In addition, the fixed-length code M1 is written in the storage region A2. If fixed-length codes are written in the overall storage region A2, the fixed-length code M1 is written over a fixed-length code that has been first written in the storage region A2 among the fixed-length codes stored in the storage region A2.

The compressed data is generated according to the aforementioned procedure and written in the storage region A3 upon the generation. The compressed file F2 is generated based on the compressed data stored in the storage region A3. The encoding dictionary D1 is included in the compressed file F2 or transferred to a computer that decompresses the compressed file F2 by another method. The procedure for the compression process is described later in further detail.

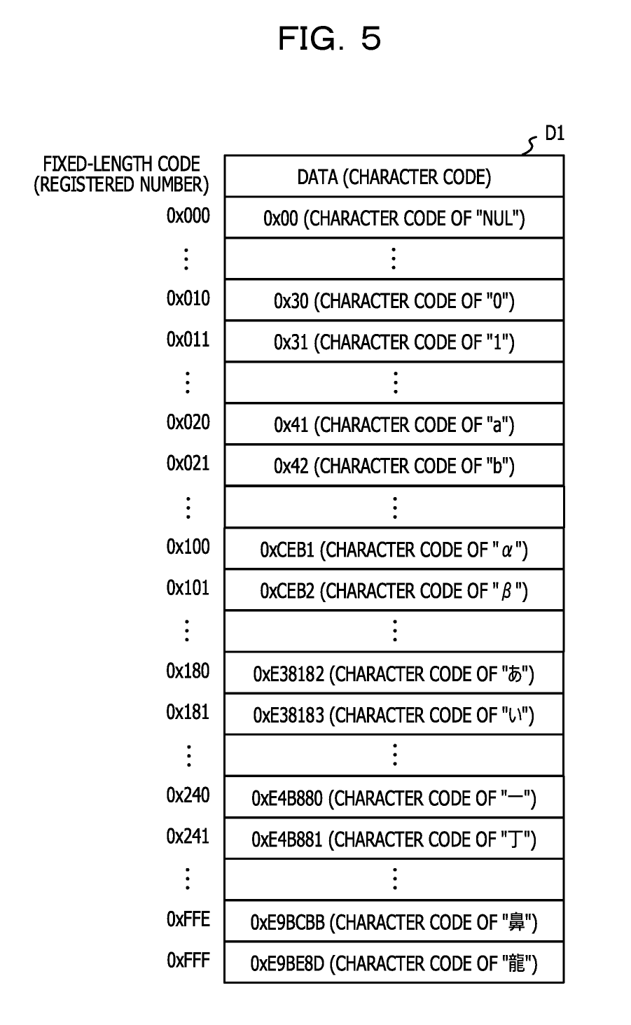

FIG. 5 illustrates an example of the encoding dictionary D1. The encoding dictionary D1 represents association relationships between character codes and fixed-length codes. The encoding dictionary D1 illustrated in FIG. 5 is an example of an encoding dictionary for Japanese documents. In the example illustrated in FIG. 5, the lengths of the fixed-length codes are 12 bits. In the example illustrated in FIG. 5, storage regions of 4 bytes are provided for the character codes, and information that represents locations at which the character codes are stored is used as the fixed-length codes. For example, since a “NUL” code is stored in the top storage region within the encoding dictionary D1, it is assumed that a fixed-length code associated with the “NUL” code (0x00) is “0x000”. For example, since a character code (0x41) of “a” is located at a position separated by 4 bytes×32 (0x020 in hexadecimal notation) from the top of the encoding dictionary D1, a fixed-length code associated with the character code of “a” is “0x020”.

In the encoding dictionary D1, the fixed-length codes are assigned to the character codes. If the length of each code is m bits, the number of the character codes to which the fixed-length codes are assigned is the m-th power of 2. In the example illustrated in FIG. 5, since the lengths of the codes are 12 bits, the fixed-length codes are assigned to the character codes of 4096 types. The fixed-length codes may be assigned to all character codes of a character set used for the file F1, or compressed codes may be assigned to a part of the character codes. Control to be executed in the case where the fixed-length codes are assigned to the part of the character codes is described later.

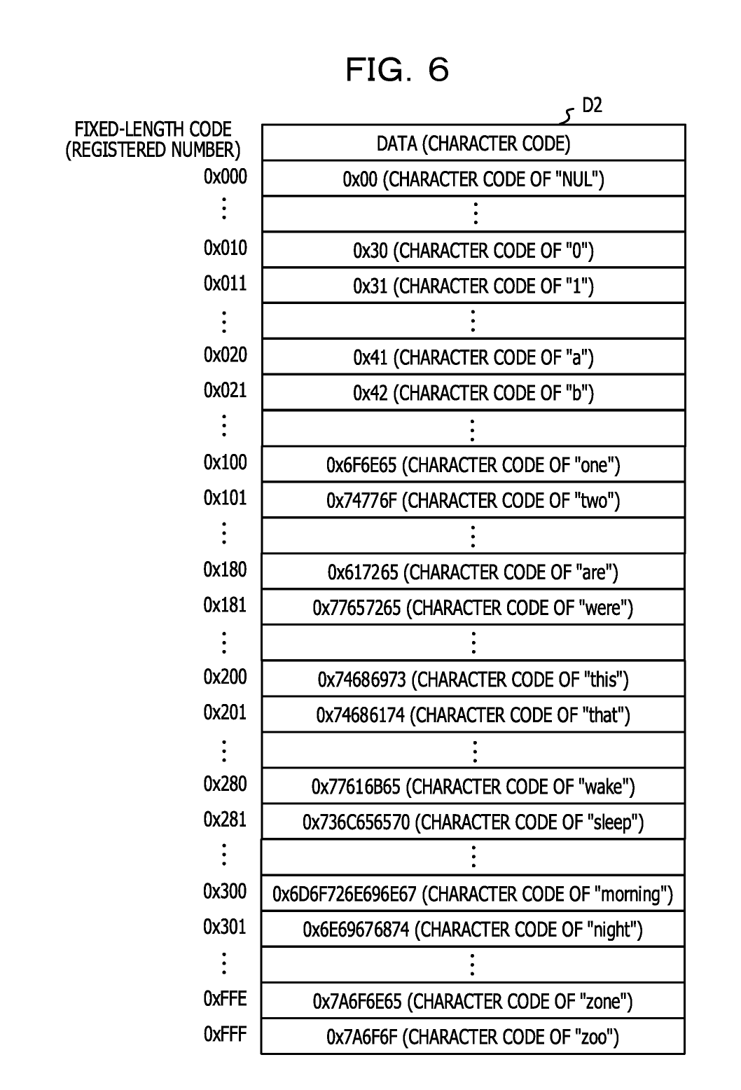

FIG. 6 illustrates an example of an encoding dictionary D2. The encoding dictionary D2 represents association relationships between character codes or character code strings and fixed-length codes. The encoding dictionary D2 illustrated in FIG. 6 is an example of an encoding dictionary for English documents. In the example illustrated in FIG. 6, the lengths of the fixed-length codes are 12 bits. In the example illustrated in FIG. 6, storage regions that each have a predetermined length are provided for the character codes or character code strings. Information that represents locations at which the character codes or character code strings are stored is used as the fixed-length codes.

In the encoding dictionary D2 illustrated in FIG. 6, fixed-length codes that are the same as the encoding dictionary illustrated in FIG. 5 are assigned to “NUL” and “a”. In the encoding dictionary D2, the other fixed-length codes are assigned to basic English words. As illustrated in FIG. 6, a fixed-length code “0x100” is assigned to an English word “one”, for example.

In the generation of a fixed-length code to be stored in the storage region A4 in the compression process illustrated in FIG. 4, the fixed-length code that corresponds to a data string matching a data string existing at a reading position of the storage region A1 is extracted from the encoding dictionary D2 (corresponding to the encoding dictionary D1 illustrated in FIG. 4) and stored in the storage region A4. In this case, for example, if a word “are” exists at the reading position of the storage region A1, a fixed-length code 0x020 (character code of “a”) and a fixed-length code 0x180 (character code of “are”) are extracted. However, 0x100 to 0xFFF are defined to be prioritized over 0x000 to 0x0FF in advance, for example.

In English documents, basic words tend to be used frequently. Approximately a half of English words included in each English document are approximately 1000 basic words. Thus, if a group of English words to which the fixed-length codes of 12 bits are assigned is used as represented by the encoding dictionary D2 illustrated in FIG. 6, most of English documents may be represented. When the encoding dictionary D2 illustrated in FIG. 6 is used, data to be compared on a byte basis multiple times is processed by comparing executed once. In the comparing executed once, the size of the data to be compared may be equal to or smaller than the lengths of the fixed-length codes. Thus, a compression rate is improved by comparing encoded fixed-length codes using the encoding dictionary D2 illustrated in FIG. 6.

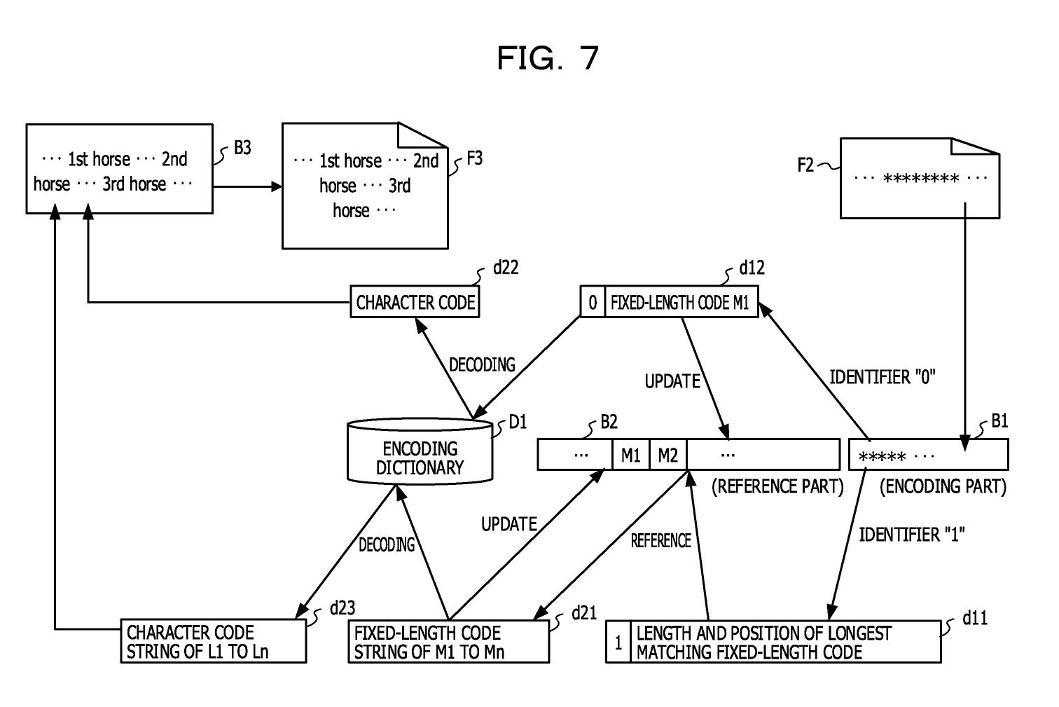

FIG. 7 illustrates an example of the decompression process. First, the storage region B1, the storage region B2, and the storage region B3 are secured in the memory, for example. Compressed data included in the compressed file F2 illustrated in FIG. 7 is loaded into the storage region B1. The storage region B1 is referred to as an encoding part or the like, for example. In addition, the encoding dictionary D1 is loaded from the compressed file F2 into the memory. As described above, the encoding dictionary D1 may not be included in the compressed file F2, and the encoding dictionary D1 used for compression may be held in advance.

The compressed data loaded in the storage region B1 is sequentially read. The decompression process is executed on the read compressed data based on an identifier included in the compressed data. As an example of the compressed data having the identifier (“0” in the example illustrated in FIG. 7) representing that the compressed data is not a code compressed based on the longest matching fixed-length code string, the compressed data d12 is illustrated in FIG. 7. The fixed-length code M1 included in the compressed data d12 is decoded based on the encoding dictionary D1. In addition, the fixed-length code M1 included in the compressed data d12 is written at an update position of the storage region B2. A character code d22 obtained by the decoding executed based on the encoding dictionary D1 is written in the storage region B3.

As an example of the compressed data including the identifier (“1” in the example illustrated in FIG. 7) representing that the compressed data is a code compressed based on the longest matching fixed-length code string, the compressed data d11 is illustrated in FIG. 7. A fixed-length code string d21 (for example, a fixed-length code string of codes M1 to Mn) is read from the storage region B2 based on information of the length and position of the longest matching fixed-length code string included in the compressed data d11. When the fixed-length code string d21 is read, the fixed-length code string d21 is written at the update position of the storage region B2 and decoded using the encoding dictionary D1. A character code string d23 (for example, a character code string of codes L1 to Ln corresponding to the fixed-length code string of the codes M1 to Mn) obtained by the decoding is written in the storage region B3.

If fixed-length codes are already written in the overall storage region B2 upon the writing at the update position of the storage region B2, the fixed-length matching code string d21 is written over a fixed-length code that has been first stored in the storage region B2 among the fixed-length codes stored in the storage region B2.

The decompressed file F3 is generated based on the data (character codes) sequentially written in the storage region B3. A procedure for the decompression process is described in further detail.

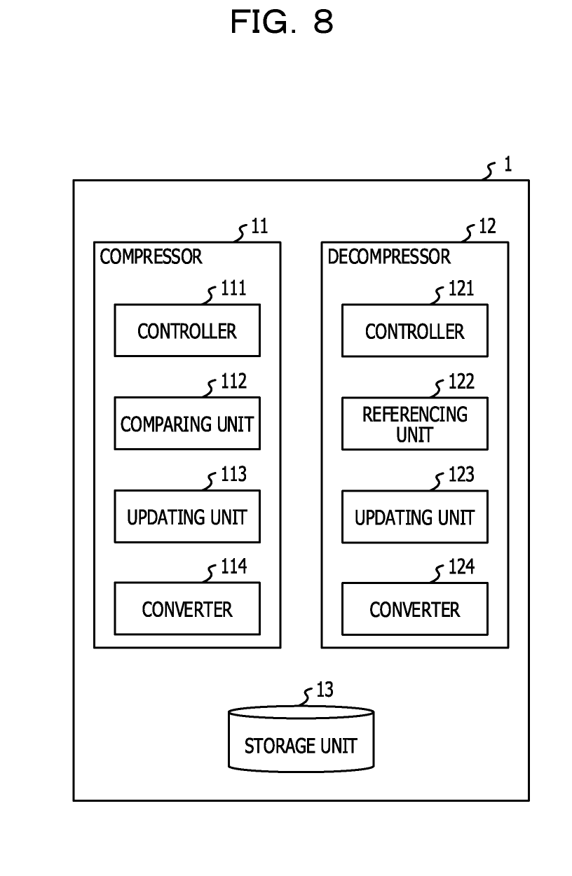

FIG. 8 illustrates an example of a functional configuration. A computer 1 that is configured to execute a process according to the embodiment includes a storage unit 13 and at least one of a compressor 11 and a decompressor 12. The compressor 11 is configured to execute the compression process, and the decompressor 12 is configured to execute the decompression process. The storage unit 13 stores the file F1 to be compressed, the compressed file F2 obtained by the compression process, the file F3 obtained by decompressing the file F2, and the like. For example, the storage unit 13 stores the encoding dictionary D1. In addition, the storage unit 13 is used as work areas of the compressor 11 and decompressor 12. The compressor 11 includes a controller 111, a comparing unit 112, an updating unit 113, and a converter 114. The decompressor 12 includes a controller 121, a referencing unit 122, an updating unit 123, and a converter 124.

The controller 111 controls the comparing unit 112 and the updating unit 113 and causes the comparing unit 112 and the updating unit 113 to achieve a compression function. The controller 111 holds data to be used for processes of the functional units and therefore secures storage regions (for example, the aforementioned storage regions A1, A2, and A3) in the storage unit 13. The controller 111 sequentially reads data stored at the reading position in the storage region A1. The converter 114 converts the data read by the controller 111 into fixed-length codes based on the encoding dictionary D1. The controller 111 causes the fixed-length codes converted by the converter 114 to be stored in the storage region A4. The comparing unit 112 executes a process of referencing fixed-length codes stored in the storage region A2 based on the fixed-length codes stored in the storage region A4. The updating unit 113 updates a fixed-length code string within the storage region A2 based on the fixed-length codes within the storage region A4. The controller 111 generates compressed data based on the results of referencing the fixed-length codes within the storage region A2 by the comparing unit 112. A procedure for executing the processes of the functional units included in the compressor 11 is described later.

The controller 121 controls the referencing unit 122 and the updating unit 123 and causes the referencing unit 122 and the updating unit 123 to achieve a decompression function. The controller 121 holds data to be used for processes of the functional units and therefore secures storage regions (for example, the aforementioned storage regions B1, B2, and B3) in the storage unit 13. The controller 121 reads compressed data stored at a reading position in the storage region B1 and determines an identifier included in the read compressed data. If the identifier is a predetermined identifier, the controller 121 causes the referencing unit 122 to execute a process of referencing fixed-length codes within the storage region B2. When fixed-length codes are obtained by the reference executed by the referencing unit 122 or by the reading from the storage region B3, the updating unit 123 updates the storage region B2 based on the obtained fixed-length codes. In addition, the converter 124 converts the obtained fixed-length codes into decompressed data based on the encoding dictionary D1. A procedure for executing processes by the functional units included in the decompressor 12 is described later.

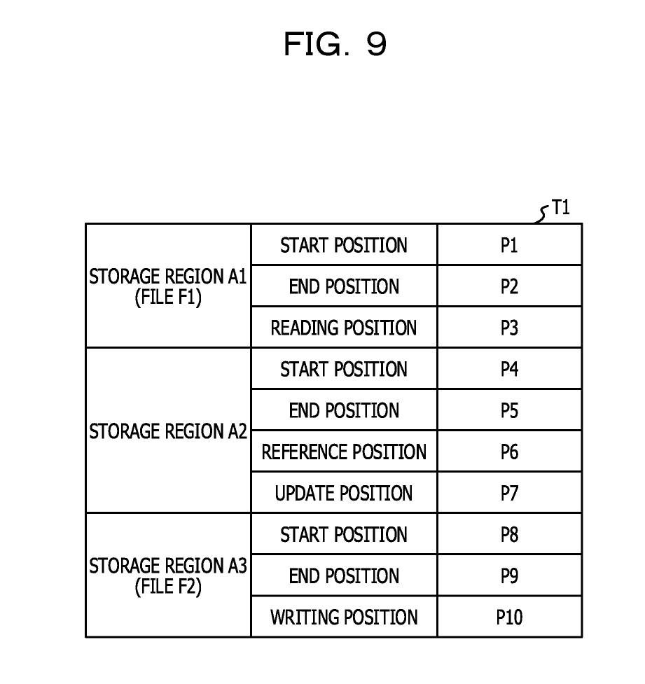

FIG. 9 illustrates an example of a positional information table T1 to be used to manage positional information of the storage regions. The positional information table T1 is used to manage the positions of the storage regions (the storage regions A1, A2, A3, and the like) to be used for the compression process within the storage unit 13. The positional information table T1 includes a start position P1, end position P2, and reading position P3 of the storage region A1, while the file F1 is loaded between the start position P1 and the end position P2. In addition, the positional information table T1 includes a start position P4, end position P5, reference position P6, and update position P7 of the storage region A2. Furthermore, the positional information table T1 includes a start position P8, end position P9, and writing position P10 of the storage region A3. Initial values of the positional information stored in the positional information table T1 are set by the controller 111. The start positions and end positions of the storage regions represent start positions and end positions at which data (for example, parts excluding a header and trailer of the file) to be compressed and decompressed is stored. For example, the initial values of the reading position P3 and start position P1 are the same, the initial values of the reference position P6, update position P7, and start position P4 are the same, and the initial values of the writing position P10 and start position P8 are the same.

The procedure for the compression process is described below.

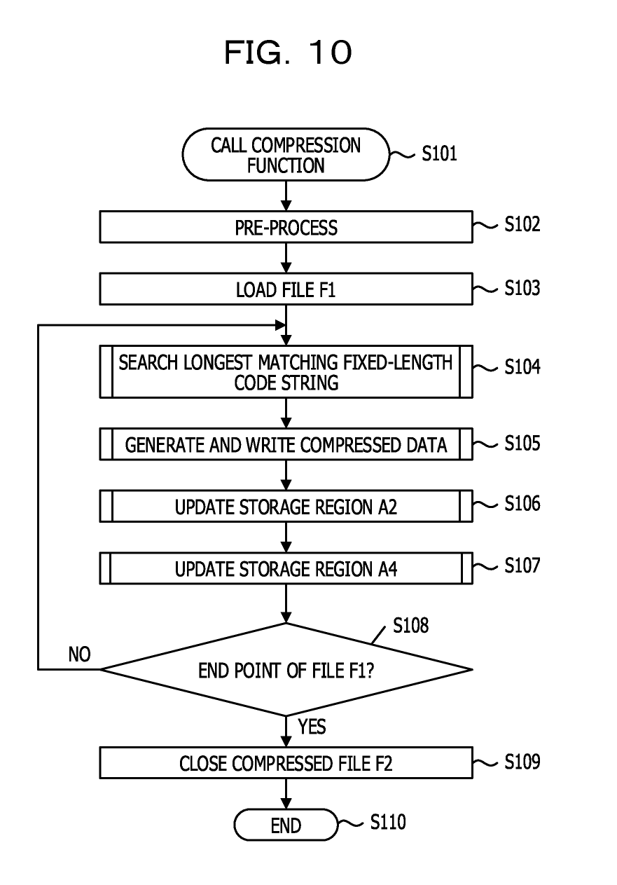

FIG. 10 illustrates an example of the procedure for the compression process. First, the compression function is called by operations of an operating system and application program included in the computer 1 (in 8101). When the compression function is called, the controller 111 executes a pre-process such as securing of, for example, the storage regions A1, A2, A3, and A4 (the storage regions A1, A2, and A3 are illustrated in FIG. 1) and setting of the positional information (for example, the positional information illustrated in FIG. 9) within the storage regions (in S102).

When the process of S102 is terminated, the controller 111 loads the content part of the file F1 to be compressed into the storage region A1 (in S103). In addition, the controller 111 sets the end position P2 based on an end portion of the file F1. Subsequently, the controller 111 executes a process of searching the longest matching fixed-length code string (in S104).

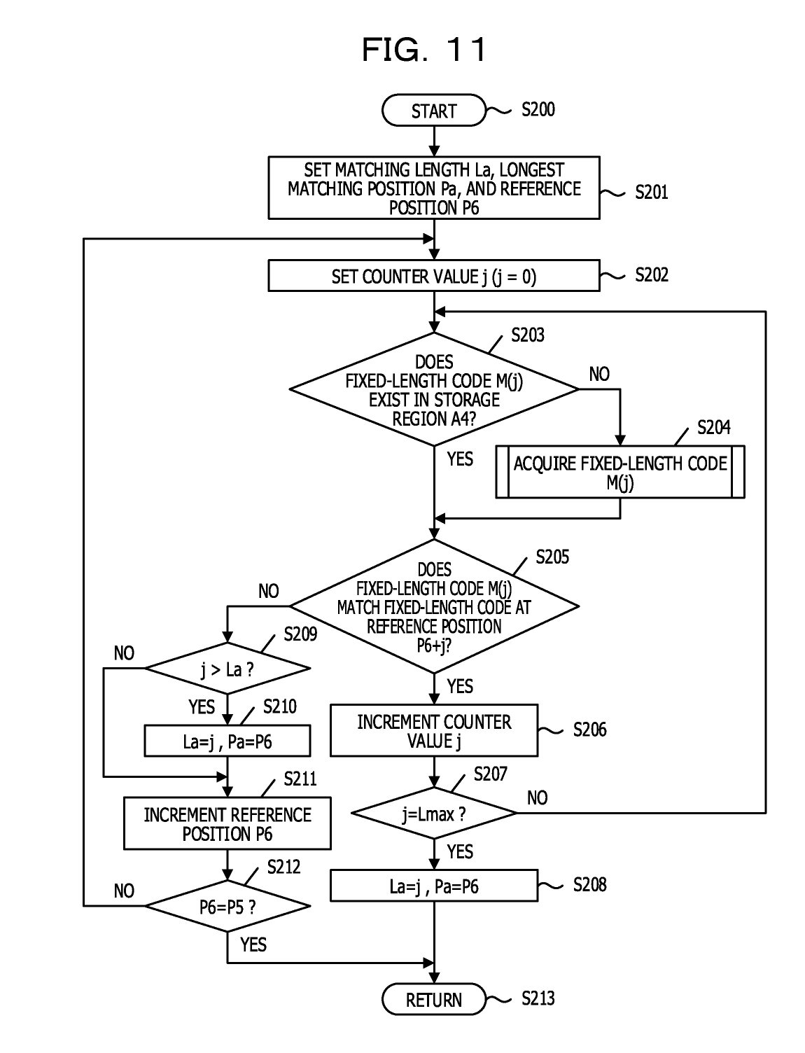

FIG. 11 illustrates an example of a procedure for the process of searching the longest matching fixed-length code string. When the process of searching the longest matching fixed-length code string is started (in S200), the controller 111 sets the initial value of the reference position P6 and initial values of a matching length La and longest matching position Pa (in S201). The reference position P6 and the longest matching position Pa are set to be the same as the start position P4 or the update position P7. For example, the matching length La is set to “0” or the like. The controller 111 sets a counter value j to an initial value (for example, j=0) (in S202).

Next, the controller 111 determines whether or not a fixed-length code M(j) exists in the storage region A4 (in S203). The fixed-length code M(j) is a fixed-length code stored at a j-th position within the storage region A4. If the fixed-length code M(j) does not exist in the storage region A4 (No in S203), the controller 111 causes the converter 114 to execute a process of acquiring the fixed-length code M(j) (in S204).

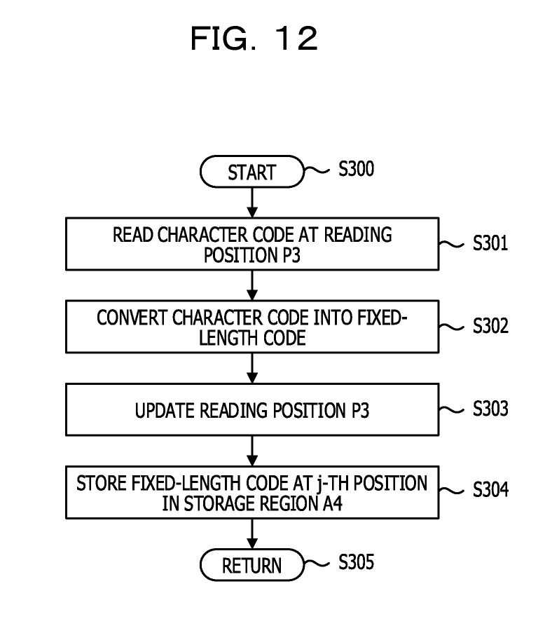

FIG. 12 illustrates an example of a procedure for the process of acquiring the fixed-length code. When the converter 114 is instructed by the controller 111 to execute the process of acquiring the fixed-length code M(j) (in S300), the converter 114 reads a character code existing at the reading position P3 of the storage region A1 (in S301). If the character code is a code of a 1-byte character, 1-byte data is read. If the character code is a code of a 2-byte character, 2-byte data is read. Next, the converter 114 reads a fixed-length code associated with the character code read in S301 from the encoding dictionary D1 based on the character code read in S301 (in S302). Then, the converter 114 updates information representing the reading position P3 and stored in the positional information table (in S303). The update of S303 is executed based on the length of the data read by the converter 114 in S301. For example, if the 1-byte character code is read, the reading position P3 is shifted by 1 byte. The controller 111 causes the fixed-length code read in S302 to be stored at the j-th position within the storage region A4 (in S304). As described above, the fixed-length code stored at the j-th position in the storage region A4 is the fixed-length mode Ma). When the converter 114 causes the fixed-length code M(j) to be stored in the storage region, the converter 114 terminates the process of acquiring the fixed-length code (in S305).

Return to FIG. 11. If the fixed-length code M(j) exists in the storage region A4 (Yes in S203) or when the process of acquiring the fixed-length code in S204 is terminated, the controller 111 causes the comparing unit 112 to execute the comparing process (in S205). In S205, the comparing unit 112 determines whether or not the fixed-length code M(j) stored in the storage region A4 matches a fixed-length code located at a position shifted from the reference position P6 within the storage region A2 based on the counter value j. The position shifted from the reference position P6 based on the counter value j is a position shifted by m×j bits from the reference position P6 if the length of each fixed-length code is m bits.

If the fixed-length codes match each other in the determination of S205 (in Yes in S205), the controller 111 increments the counter value j (in S206). Next, the controller 111 determines whether or not the counter value j reaches an upper limit Lmax (j=Lmax) (in S207). The upper limit Lmax is a value set as an upper limit on the matching length La. If the number of bits used to represent the matching length La is defined by m1 and a compressed code format, a value obtained by subtracting 1 from the m1-th power of 2 is set as the upper value, for example. If the counter value j does not reach the upper limit Lmax (No in S207), the controller 111 executes the process of S203. If the counter value j reaches the upper limit Lmax (Yes in S207), the controller 111 substitutes the counter value j into the matching length La and substitutes the reference position P6 into the longest matching position Pa (in S208). A symbol “=” represented by S208 in FIG. 11 is an assignment operator.

If the fixed-length codes do not match each other in the determination of S205 (No in S205), the controller 111 determines whether or not the counter value j is larger than the matching length La (in S209). If the counter value j is larger than the matching length La (Yes in S209), the controller 111 substitutes the counter value j into the matching length La and substitutes the reference position P6 into the longest matching position Pa (in S210). A symbol “=” represented by S210 in FIG. 11 represents an assignment operator. If the counter value j is equal to or smaller than the matching length La (No in S209) or when the process of S210 is executed, the controller 111 increments a value of the reference position P6 within the storage region A2 (in S211). Specifically, the value of the reference position P6 is incremented using, as a unit, the length of each fixed-length code stored in the storage region A2, and the reference position P6 is shifted by m bits if the length of each fixed-length code is m bits. Next, the controller 111 determines whether or not the reference position P6 reaches the end position P5 of the storage region A2 (in S212). If the reference position P6 does not reach the end position P5 in the determination of S212 (No in S212), the controller 111 executes the process of S202.

When the process of S208 is executed or if the reference position P6 reaches the end position P5 (Yes in S212), the controller 111 terminates the process of searching the longest matching fixed-length code string (in S213). The longest matching fixed-length code string obtained as a result of the search process of S104 exists from the longest matching position Pa within the storage region A2 and has the matching length La when the process of S104 is terminated. The matching length La represents the number of matching codes. Thus, if the length of each fixed-length code is m bits, the length of the longest matching fixed-length code string is La×m bits.

Subsequently, the controller 111 executes a process of generating and writing compressed data based on the results of the search process of S104 (in S105).

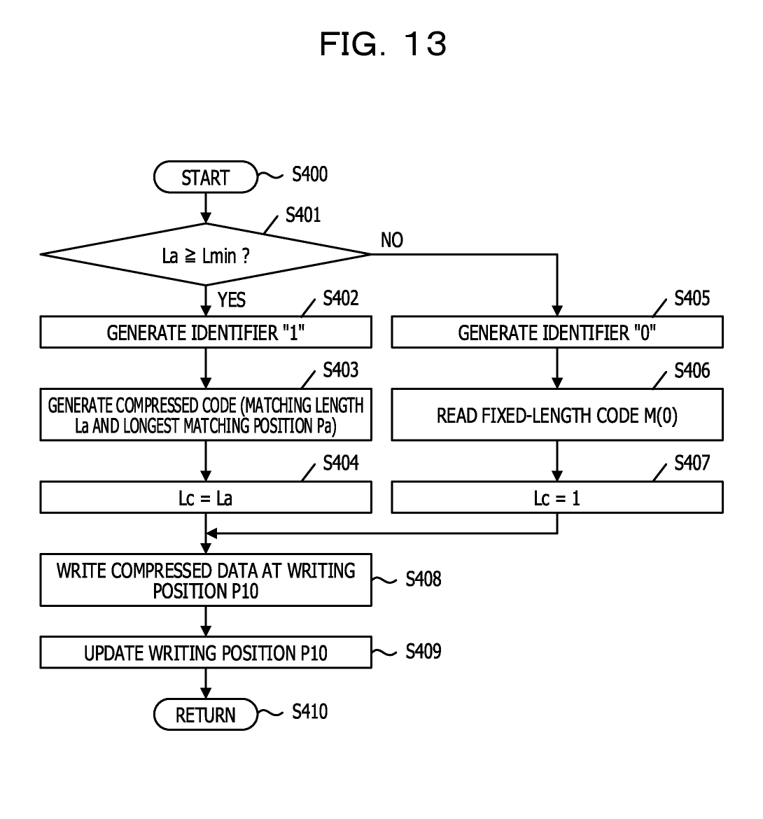

FIG. 13 illustrates an example of a procedure for a writing process. When the process of generating and writing the compressed data is started (in S400), the controller 111 determines whether or not the matching length La is equal to or larger than the lower limit Lmin (in S401). The lower limit Lmin is a value set as a lower limit on the matching length La. For example, if the compressed code format is defined to ensure that the number of bits to be used to represent the matching length La is m1 and the number of bits to be used to represent the longest matching position Pa is m2, an inequality of (La×m<m1+m2) may be satisfied. In this case, the size of compressed data generated using a fixed-length code string is smaller than the size of compressed data generated from a code compressed using the longest matching fixed-length code string. For example, if the matching length La is equal to or larger than the lower limit Lmin, the lower limit Lmin is set to ensure that La×m≧m1+m2. The setting of the lower limit is adjusted based on other settings (for example, settings of values of m1, m2, m, and the like).

If the matching length La is equal to or larger than the lower limit Lmin (Yes in S401), the controller 111 generates information of the identifier “1” (in S402). Subsequently, the controller 111 generates information of m1 bits representing the matching length La and information of m2 bits representing the longest matching position Pa (in S403). In S403, the controller 111 generates continuous information arranged in order of the identifier “1”, the matching length La, and the longest matching position Pa, for example. Next, the controller 111 substitutes the matching length La into a movement amount Lc (in S404). The movement amount Lc represents the number of fixed-length codes subjected to the compression process for the generation of compressed data. Since fixed-length codes of which the number corresponds to the matching length La are converted into compressed codes to be generated in S403, the movement amount Lc is equal to the matching length La.

If the matching length La is smaller than the lower limit Lmin (No in S401), the controller 111 generates information of the identifier “0” (in S405). Subsequently, the controller 111 reads a fixed-length code M(0) stored in the storage region A4 (in S406). In S406, the controller 111 generates information obtained by aggregating the identifier “0” generated in S405 and the fixed-length code M(0) read from the storage region A4. In addition, the controller 111 substitutes 1 into the movement amount Lc (in S407).

When the process of S404 or S407 is executed, the controller 111 writes compressed data at the writing position P10 in the storage region A3 (in S408). The compressed data is information generated in S403 or S406. In addition, the controller 111 updates the writing position P10 based on the length of the compressed data written in S408. For example, the length of the compressed data is 1+m1+m2 bits if the compressed data is the compressed data generated in S403. For example, the length of the compressed data is 1+m bits if the compressed data is the compressed data generated in S406. When the process of S409 is executed, the controller 111 terminates the process of generating and writing the compressed data (in S410).

Return to FIG. 10 to continue to describe the process. When the process of generating and writing the compressed data is executed, the controller 111 causes the updating unit 113 to execute a process of updating the storage region A2 (in S106).

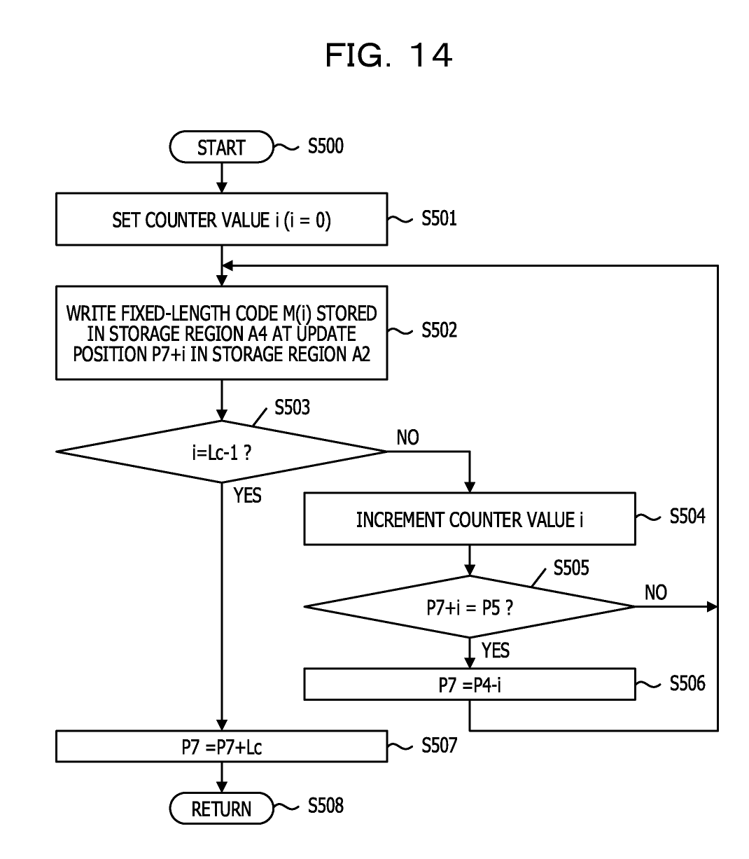

FIG. 14 illustrates an example of a procedure for the process of updating the storage region A2. When the updating unit 113 is instructed by the controller 111 to execute the process of updating the storage region A2 (in S500), the updating unit 113 sets a counter value i to an initial value (i=0) (in S501). Next, the updating unit 113 writes a fixed-length code M(i) stored in the storage region A4 at a position shifted from the update position P7 of the storage region A2 based on the counter value i (in S502). Specifically, the position at which the fixed-length code M(i) is written in S502 is a position shifted by m×i bits from the update position P7 if the length of each fixed-length code is m bits. In other words, if the update position P7 is represented using the length of each fixed-length code as a unit and the length of each fixed-length code is m bits, the position at which the fixed-length code M(i) is written in S502 is a position represented by P7+i.

Next, the updating unit 113 determines whether or not the counter value i reaches a value obtained by subtracting 1 from the movement amount Lc (in S503). Fixed-length codes that are stored in the storage region A4 and converted into compressed codes are reflected in the storage region A2 by executing the process until the counter value i reaches the value obtained by subtracting 1 from the movement amount Lc.

If the counter value i does not reach the value obtained by subtracting 1 from the movement amount Lc (No in S503), the updating unit 113 increments the counter value i (in S504). In addition, the updating unit 113 determines, based on the counter value i incremented in S504, whether or not a value obtained by summing the update position P7 and the counter value i reaches the end position P5 of the storage region A2 (in S505). If the value obtained by summing the update position P7 and the counter value i reaches the value of the end position P5 of the storage region A2 (Yes in S505), the updating unit 113 substitutes a value obtained by subtracting the counter value i from the start position P4 of the storage region A2 into the update position P7 (in S506). By the processes of S505 and S506, the storage region A2 is repeatedly used while a fixed-length code is not stored outside the storage region A2. If the value obtained by summing the update position P7 and the counter value i does not reach the end position P5 of the storage region A2 (No in S505) or when the process of S506 is executed, the updating unit 113 executes the process of S502.

If the counter value i reaches the value obtained by subtracting 1 from the movement amount Lc (Yes in S503), the updating unit 113 updates the update position P7 of the storage region A2 (in S507). Specifically, a value obtained by adding the movement amount Lc to the update position P7 is substituted into the update position P7. When the process of S507 is terminated, the updating unit 113 terminates the process of updating the storage region A2 (in S508).

Return to 10 to continue to describe the process. When the process of updating the storage region A2 by the updating unit 113 is terminated, the controller 111 causes the updating unit 113 to execute a process of updating the storage region A4 (in S107).

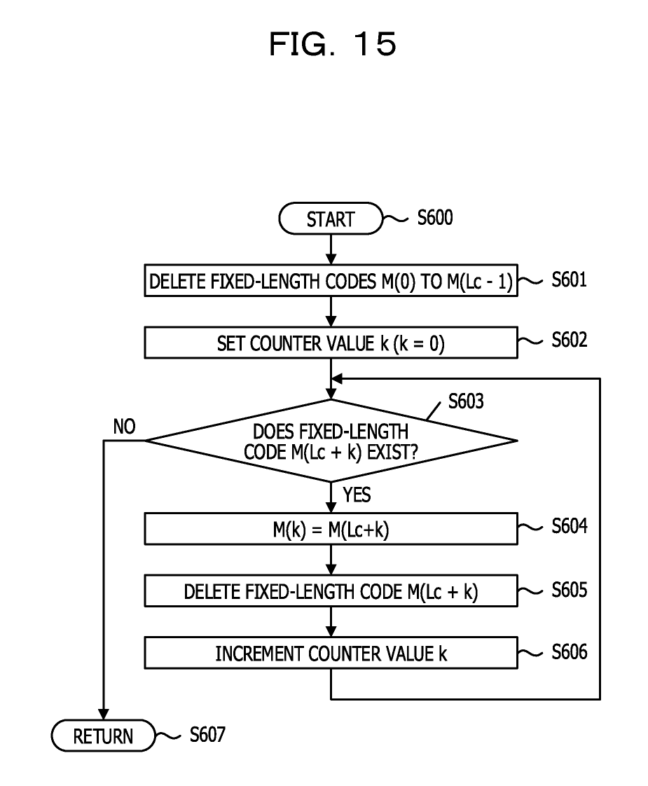

FIG. 15 illustrates an example of a procedure for the process of updating the storage region A4. When the updating unit 113 is instructed by the controller 111 to execute the process of updating the storage region A4 (in S600), the updating unit 113 deletes fixed-length codes M(0) to M(Lc−1) within the storage region A4 (in S601). Compressed data that is associated with the fixed-length codes M(0) to M(Lc−1) is already generated and copied into the storage region A2. In addition, the updating unit 113 sets a counter value k to an initial value (k=0) (in S602).

Next, the updating unit 113 determines whether or not a fixed-length code M(Lc+k) exists (in S603). If the fixed-length code M(Lc+k) exists (Yes in S603), the updating unit 113 copies the fixed-length code M(Lc+k) into the position of the counter value k within the storage region A4 (in S604). Specifically, the updating unit 113 causes a fixed-length code M(k) to be stored in the storage region A4. In addition, the updating unit 113 deletes the fixed-length code M(Lc+k) (in S605). Then, the updating unit 113 increments the counter value k (in S606). When the process of S606 is executed, the updating unit 113 executes the process of S603. If the fixed-length code M(Lc+k) does not exist in the determination of S603 (No in S603), the updating unit 113 terminates the process of updating the storage region A4 (in S607).

When the process of updating the storage region A4 by the updating unit 113 is terminated, the controller 111 determines whether or not the compression process is executed until the end point of the file F1 (in S108). In S108, the controller 111 determines whether or not the reading position P3 of the storage region A1 reaches the end position P2 of the storage region A1, for example. If the compression process is not executed until the end point of the file F1 (No in S108), the controller 111 executes the process of S104. If the compression process is executed until the end point of the file F1 (Yes in S108), the controller 111 executes a process of generating the compressed file F2 based on a compressed data group stored in the storage region A3 (in S109). Specifically, the compressed file F2 is closed and stored in the storage unit 13. When the process of S109 is terminated, the controller 111 terminates the compression process (in S110). In the process of S110, the controller 111 provides a notification representing the termination of the compression process for the call of the compression function, for example. The notification that represents the termination of the compression process includes information representing a region for storing the compressed file F2 and the like, for example.

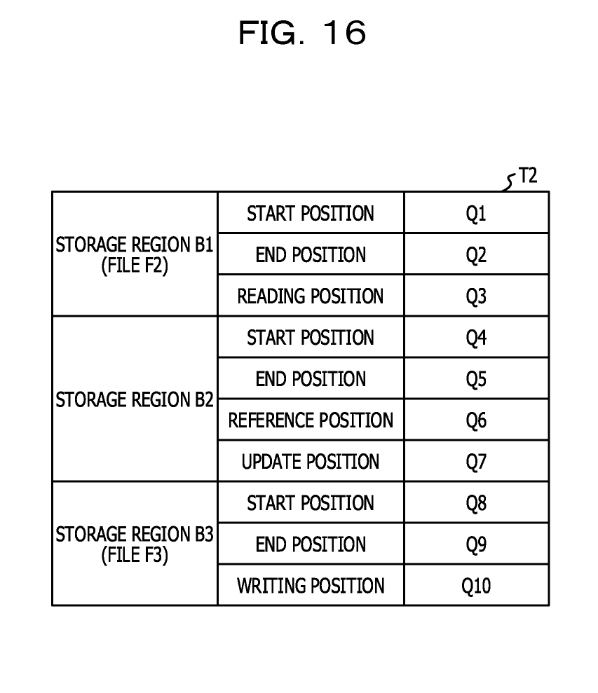

FIG. 16 illustrates an example of a positional information table T2 to be used to manage positional information of the storage regions. The positional information table T2 is used to manage the positions of the storage regions (storage regions B1, B2, B3, and the like) to be used for the decompression process within the storage unit 13. The positional information table T2 includes a start position Q1, end position Q2, and reading position Q3 of the storage region B1, while the compressed file F2 is loaded between the start position Q1 and the end position Q2. In addition, the positional information table T2 includes a start position Q4, end position Q5, reference position Q6, and update position Q7 of the storage region B2. Furthermore, the positional information table T2 includes a start position Q8, end position Q9, and writing position Q10 of the storage region B3. Initial values of the positional information stored in the positional information table T2 are set by the controller 111. The start positions and end positions of the storage regions represent start positions and end positions at which data (for example, parts excluding a header and trailer of the file) to be compressed and decompressed is stored. For example, the initial values of the reading position Q3 and start position Q1 are the same, the initial values of the reference position Q6, update position Q7, and start position Q4 are the same, and the initial values of the writing position Q10 and start position Q8 are the same.

A procedure for the decompression process is described below.

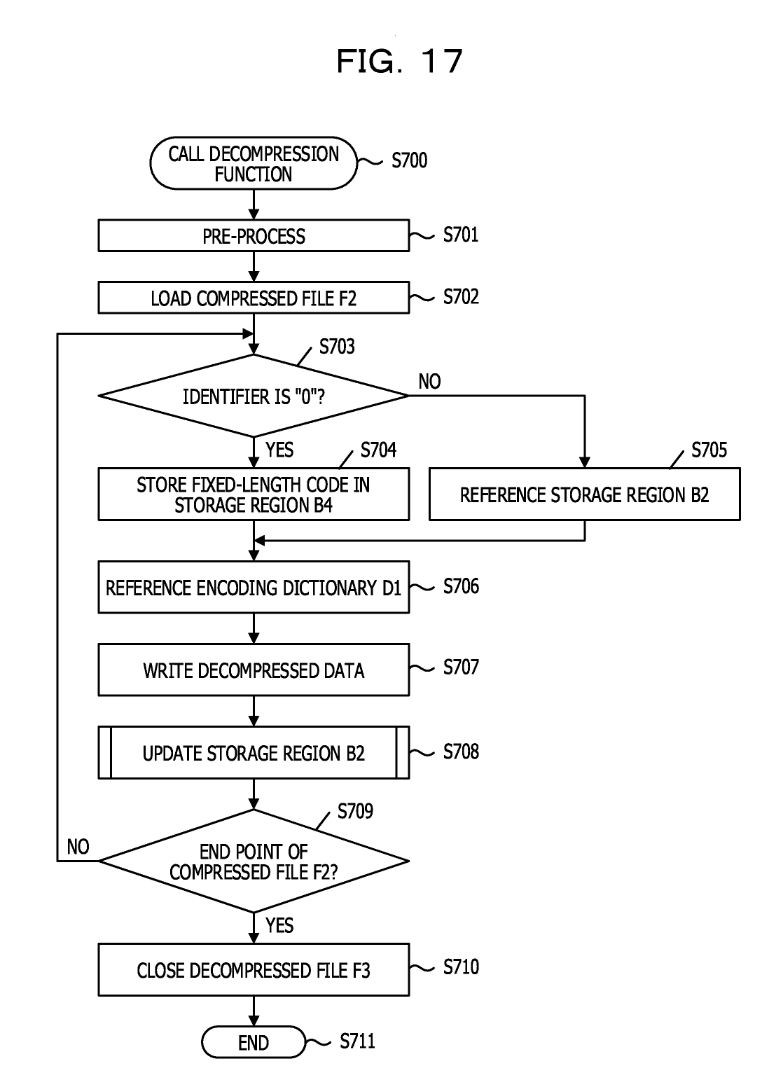

FIG. 17 illustrates an example of the procedure for the decompression process. First, the decompression function is called by operations of the operating system and application program included in the computer 1 (in S700). When the decompression function is called, the controller 121 executes a pre-process such as securing of the storage regions B1, B2, B3, and B4 (the storage regions B1, B2, and B3 are illustrated in FIG. 2) and setting of the positional information (for example, the positional information illustrated in FIG. 16) within the storage regions (in S701).

When the process of S701 is terminated, the controller 121 loads a content part of the compressed file F2 into the storage region B1 (in S702). In addition, the controller 121 sets the end position Q2 based on an end portion of the compressed file F2. Next, the controller 121 determines whether an identifier included in compressed data stored at the reading position Q3 in the storage region B1 represents that the compressed data is not data compressed based on the longest matching data string (or the identifier is “0”) or is the data compressed based on the longest matching data string (or the identifier is “1”) (in S703).

If the identifier is “0” (Yes in S703), the controller 121 reads a fixed-length code included in the compressed data stored at the reading position Q3 and causes the read fixed-length code to be stored in the storage region B4 (in S704). For example, it is assumed that the fixed-length code stored in the storage region B4 is a fixed-length code M(0). In addition, it is assumed that the movement amount Lc that represents the number of fixed-length codes to be converted is 1 (Lc=1).

If the identifier is “1” (No in S703), the controller 121 causes the referencing unit 122 to reference the storage region B2 based on the position Pa and length La included in the compressed data stored at the reading position Q3. The referencing unit 122 reads a fixed-length code string with the length La from the position Pa of the storage region B2 and causes the read fixed-length code string to be stored in the storage region B4 (in S705). It is assumed that a fixed-length code string stored in the storage region B4 is the fixed-length codes M(0) to M(Lc−1). In S705, the controller 121 sets the movement amount Lc to La (Lc=La).

If S704 or S705 is executed, the controller 121 causes the converter 124 to convert the fixed-length codes M(0) to M(Lc−1) stored in the storage region B4 based on the encoding dictionary D1 (in S706). In S704, the converter 124 identifies a position within the encoding dictionary D1 based on a value of the fixed-length code and reads decompressed data (character code). In the example of the encoding dictionary D1 illustrated in FIG. 5, if the value of the fixed-length code is 0x020, a character code of “a” is read.

When the decompressed data is read in S706, the controller 121 writes the read decompressed data at the writing position Q10 in the storage region B3 (in S707). In addition, the controller 121 updates the writing position Q10 based on the length of the written decompressed data. When the process of S707 is executed, the controller 121 causes the updating unit 123 to update the storage region B2 (in S708).

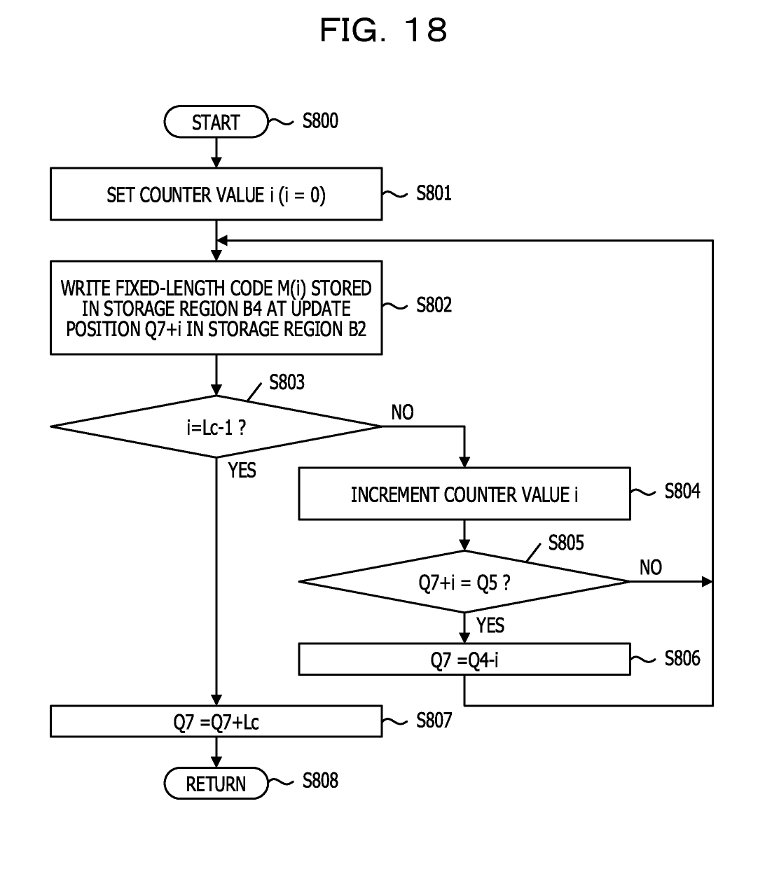

FIG. 18 illustrates an example of a procedure for a process of updating the storage region B2. When the updating unit 123 instructed by the controller 121 to execute the process of updating the storage region B2 (in S800), the updating unit 123 sets the counter value i to the initial value (i=0) (in S801). Next, the updating unit 123 writes, at a position shifted from the update position Q7 of the storage region B2 based on the counter value i, the fixed-length code M(i) stored in the storage region B4 (in S802). Specifically, if the length of each fixed-length code is m bits, the position at which the fixed-length code M(i) is written in S802 is a position shifted from the update position Q7 by m×i bits. In other words, the position at which the fixed-length code M(i) is written in S802 is a position represented by Q7+i if the update position Q7 is represented using the length of each fixed-length code as a unit and the length of each fixed-length code is m bits.

Next, the updating unit 123 determines whether or not the counter value i reaches a value obtained by subtracting 1 from the movement amount Lc (in S803). By executing the process until the counter value i reaches the value obtained by subtracting 1 from the movement amount Lc, fixed-length codes stored in the storage region B4 are reflected in the storage region B2.

If the counter value i does not reach the value obtained by subtracting 1 from the movement amount Lc (No in S803), the updating unit 123 increments the counter value i (in S804). In addition, the updating unit 123 determines, based on the counter value i incremented in S804, whether or not a value obtained by summing the update position Q7 and the counter value i reaches the end position Q5 of the storage region B2 (in S805). If the value obtained by summing the update position Q7 and the counter value i reaches the end position Q5 of the storage region B2 (Yes in S805), the updating unit 123 substitutes a value obtained by subtracting the counter value i from the start position Q4 of the storage region B2 into the update position Q7 (in S806). By the processes of S805 and S806, the storage region B2 is repeatedly used while a fixed-length code is not stored outside the storage region B2. If the value obtained by summing the update position Q7 and the counter value i does not reach the end position Q5 of the storage region B2 (No in S805) or when the process of S806 is executed, the updating unit 123 executes the process of S802.

If the counter value i reaches the value obtained by subtracting 1 from the movement amount Lc (Yes in S803), the updating unit 123 updates the update position Q7 of the storage region B2 (in S807). Specifically, the updating unit 123 substitutes a value obtained by adding the movement amount Lc to the update position Q7 into the update position Q7. When the process of S807 is terminated, the updating unit 123 terminates the process of updating the storage region B2 (in S808). In S808, the updating unit 123 clears information within the storage region B4.

When the process of updating the storage region B2 by the updating unit 123 is terminated, the controller 121 determines whether or not the decompression process is executed until the end point of the compressed file F2 (in S709). In S709, the controller 121 makes the determination based on whether or not the reading position Q3 of the storage region B1 reaches the end position Q2 of the storage region B1. If the reading position Q3 does not reach the end position Q2 (No in S709), the controller 121 executes the process of S703. If the reading position Q3 reaches the end position Q2 (Yes in S709), the controller 121 generates the decompressed file F3 using the decompressed data stored in the storage region B3 and causes the generated decompressed file F3 to be stored in the storage unit 13 (in S710). Specifically, the decompressed file F3 is closed. When the process of S710 is terminated, the controller 121 terminates the decompression process (in S711). In the process of S711, the controller 121 provides a notification representing the termination of the decompression process for the call of the decompression function. The notification that represents the termination of the decompression process includes information representing a region for storing the decompressed file F3 and the like, for example.

Hardware and software that are used in the embodiment are described below.

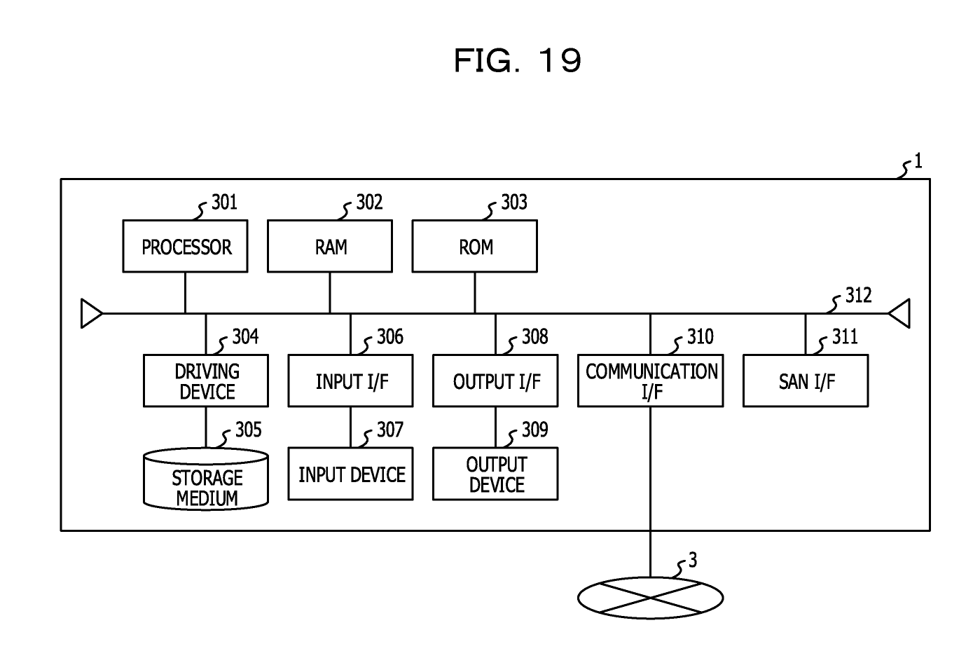

FIG. 19 illustrates an example of a hardware configuration of the computer 1. The computer 1 includes a processor 301, a random access memory (RAM) 302, a read only memory (ROM) 303, a driving device 304, a storage medium 305, an input interface (I/F) 306, an input device 307, an output interface (I/F) 308, an output device 309, a communication interface (I/F) 310, a storage area network (SAN) interface (I/F) 311, a bus 312, and the like, for example. The hardware parts of the computer 1 are connected to each other through the bus 312.

The RAM 302 is a readable and writable memory device. For example, a semiconductor memory such as a static RAM (SRAM) or a dynamic RAM (DRAM) may be used as the RAM 302. Alternatively, a flash memory may be used as the RAM 302 even though the flash memory is not a RAM. The ROM 303 includes a programmable ROM (PROM) and the like. The driving device 304 is configured to both read and write information from and in the storage medium 305 or either read or write information from or in the storage medium 305. The storage medium 305 is configured to store information written by the driving device 304. The storage medium 305 is, for example, a hard disk, a flash memory such as a solid state drive (SDD), a compact disc (CD), a digital versatile disc (DVD), a Blu-ray disc, or the like. For example, the computer 1 may include driving devices 304 and storage media 305 for multiple types of storage media.

The input interface 306 is a circuit connected to the input device 307 and configured to transfer an input signal received from the input device 307 to the processor 301. The output interface 308 is a circuit connected to the output device 309 and configured to cause the output device 309 to execute outputting in accordance with an instruction from the processor 301. The communication interface 310 is a circuit configured to control communication to be executed through the network 3. The communication interface 310 is, for example, a network interface card (NIC) or the like. The SAN interface 311 is a circuit configured to control communication with a storage device connected to the computer 1 by a storage area network. The SAN interface 311 is, for example, a host bus adapter (HBA) or the like.

The input device 307 is configured to transmit an input signal in accordance with an operation. The input device 307 is, for example, a key device such as a keyboard or buttons attached to a body of the computer 1 or a pointing device such as a mouse or a touch panel. The output device 309 is configured to output information in accordance with control of the computer 1. The output device 309 is, for example, an image output device (display device) such as a display or an audio output device such as a speaker. Alternatively, an input and output device such as a touch screen may be used as the input device 307 and the output device 309, for example. The input device 307 and the output device 309 may be unified with the computer 1 or may not be included in the computer 1 and may be connected to the computer 1 from outside the computer 1.

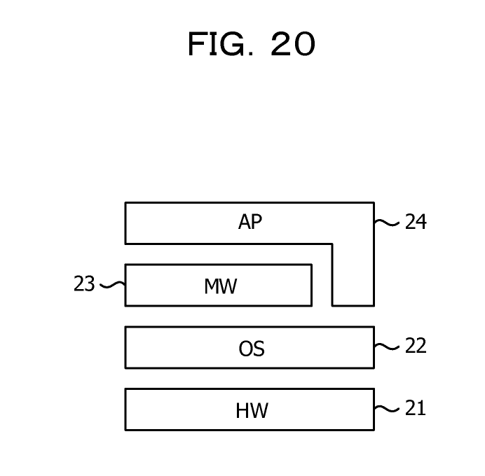

For example, the processor 301 reads programs stored in the ROM 303 or the storage medium 305 into the RAM 302 and executes the processes of the compressor 11 or the processes of the decompressor 12 in accordance with procedures of the read programs. In this case, the RAM 302 is used as a work area of the processor 301. The function of the storage unit 13 is achieved by causing the ROM 303 and the storage medium 305 to store program files (an application program 24, middleware 23, an OS 22 (that are described later), and the like) and data files (the file F1 to be compressed, the compressed file F2, the decompressed file F3, and the like) and causing the RAM 302 to be used as the work area of the processor 301. The programs to be read by the processor 301 are described later with reference to FIG. 20.

The functional blocks included in the compressor 11 configured to execute the processes illustrated in FIGS. 10 to 15 are described in further detail. The controller 111 is achieved by causing the processor 301 to control the RAM 302 (exclusive control or the like), execute a process of accessing to the RAM 302, execute calculation on information obtained by the access process, execute an arithmetic process in the processor 301, and the like. The comparing unit 112 is achieved by causing the processor 301 to execute the process of accessing to the RAM 302, execute calculation for comparing of information obtained by the access process, and the like. The updating unit 113 is achieved by causing the processor 301 to execute the process of accessing to the RAM 302 and the like. The converter 114 is achieved by causing the processor 301 to execute the process of accessing to the RAM 302, execute calculation for comparing of information obtained by the access process, and the like.

The functional blocks included in the decompressor 12 configured to execute the processes illustrated in FIGS. 17 and 18 are described in further detail. The controller 121 is achieved by causing the processor 301 to control the RAM 302 (exclusive control or the like), execute the process of accessing to the RAM 302, execute calculation on information obtained by the access process, execute an arithmetic process in the processor 301, and the like. The referencing unit 122 is achieved by causing the processor 301 to execute the process of accessing to the RAM 302 and the like. The updating unit 123 is achieved by causing the processor 301 to execute the process of accessing to the RAM 302 and the like. The converter 124 is achieved by causing the processor 301 to execute the process of accessing to the RAM 302, execute calculation for comparing of information obtained by the access process, and the like.

FIG. 20 illustrates an example of a configuration of the programs that are executed in the computer 1. In the computer 1, the operating system (OS) 22 that is configured to control a group 21 of the hardware parts (301 to 312) illustrated in FIG. 19 is executed. The processor 301 operates so as to control and manage the hardware group 21 in accordance with a procedure based on the OS 22 and thereby causes the hardware group 21 to execute processes in accordance with the application program 24 and the middleware 23. In the computer 1, the middleware 23 or the application program 24 is read into the RAM 302 and executed by the processor 301.

When the compression function is called, the functions of the compressor 11 are achieved by causing the processor 301 to execute processes based on at least a part of the middleware 23 or application program 24 (and control the hardware group 21 based on the OS 22 so as to execute the processes). In addition, when the decompression function is called, the functions of the decompressor 12 are achieved by causing the processor 301 to execute processes based on at least a part of the middleware 23 or application program 24 (and control the hardware group 21 based on the OS 22 so as to execute the processes). The compression function and the decompression function may be included in the application program 24 or may be called and executed in accordance with the application program 24 and may be a part of the middleware 23. Alternatively, the compression function and the decompression function may be one function of the OS 22.

If the compression function is included in the application program 24 (or the middleware 23), the number of times of comparing executed in order to extract data matching data to be processed is suppressed, and a load caused by memory access by the processor 301 is suppressed. Thus, a time when the work area is secured on the RAM 302 is reduced.

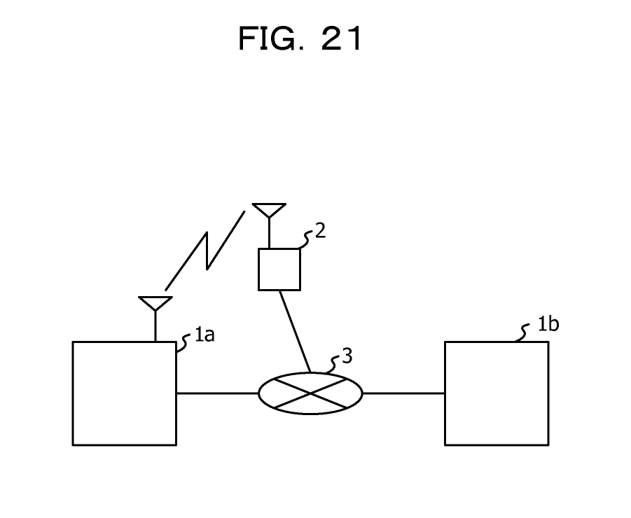

FIG. 21 illustrates an example of a configuration of devices included in a system according to the embodiment. The system illustrated in FIG. 21 includes a computer 1a, a computer 1b, a base station 2, and a network 3. The computer 1a is connected to the network 3 either wirelessly or through a cable or both wirelessly and through a cable, while the computer 1b is connected to the network 3.

Each of the compressor 11 and decompressor 12 illustrated in FIG. 8 may be included in any of the computers 1a and 1b illustrated in FIG. 21. For example, the computer 1b may include the compressor 11 (including the controller 111, the comparing unit 112, the updating unit 113, and the converter 114), and the computer 1a may include the decompressor 12 (including the controller 121, the referencing unit 122, the updating unit 123, and the converter 124). Alternatively, the computer 1a may include the compressor 11, and the computer 1b may include the decompressor 12. Each of the computers 1a and 1b may include the compressor 11 and the decompressor 12.

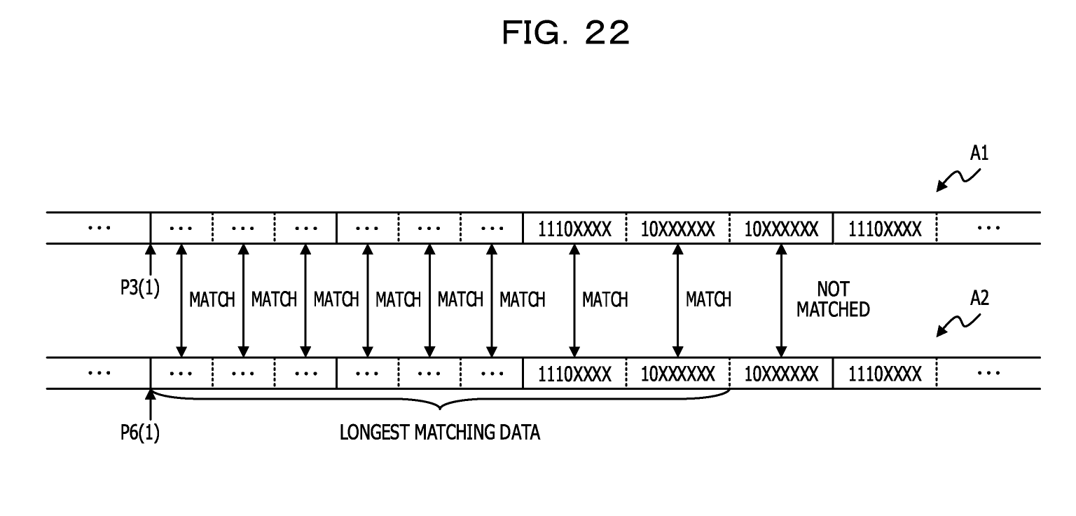

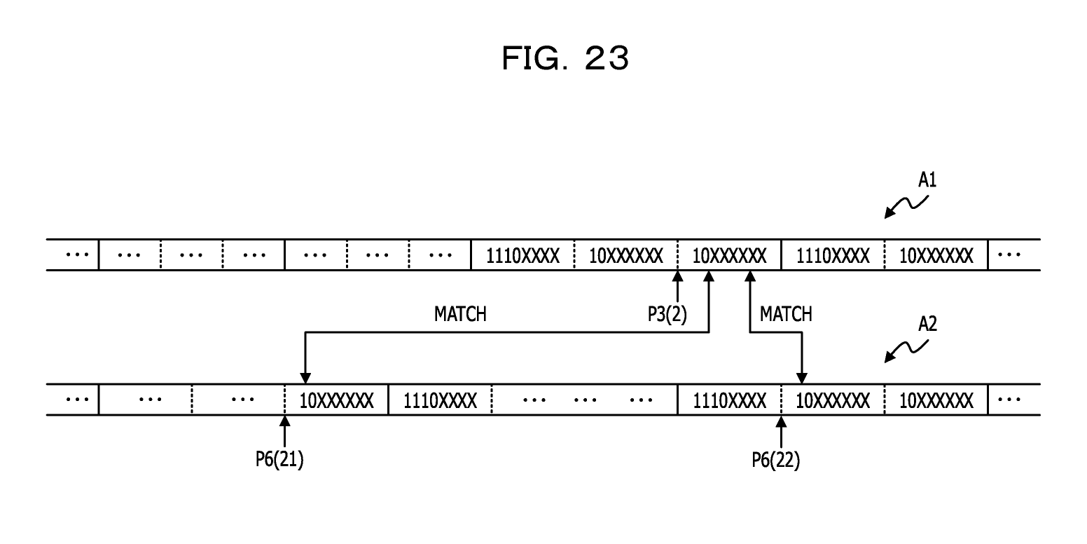

An example in which data whose positions are different in character codes is compared is additionally described with reference to FIGS. 22 and 23.

In the assignment of UTF-8 codes, values of the second and subsequent bytes of a character code of 2 bytes or more are in a common range (of 0x80 to 0xBF). Thus, if data that uses character codes each representing a respective character by multiple bytes is compared on a byte basis, and the character codes are different, only parts of the data may match each other. For example, the third byte of a certain 4-byte character code may match the second byte of another 3-byte character code. In such a case, a comparing process exemplified in FIGS. 22 and 23 may be executed.

FIG. 22 illustrates an example of a process of comparing data units different from data units forming data to be compressed. FIG. 22 illustrates a part of the storage region A1 and a part of the storage region A2. Boundaries included in the storage regions and represented by dotted lines are boundaries between 1-byte units, while boundaries included in the storage regions and represented by solid lines are boundaries between character codes. In the example illustrated in FIG. 22, the 3-byte character codes are exemplified as data within the storage regions.

The example illustrated in FIG. 22 assumes that a position that is located in the storage region A1 and from which data to be processed is read is a reading position P3(1) and that the position of data stored in the storage region A2 and to be compared with the data to be processed is a reference position P6(1). As exemplified in FIG. 22, when the 3-byte character codes are compared on a byte basis, the end of the longest matching data may exist at a position different from a boundary between character codes. FIG. 22 illustrates the example in which two 3-byte character codes and 2 bytes of a 3-byte character code are extracted as the longest matching data. A compressed code is generated based on the position and length of the extracted longest matching data in the compression process using LZ77. Thus, the compressed code is generated based on the reference position P6(1) and the length (8 bytes) of the longest matching data.

When the compressed code is generated based on the longest matching data illustrated in FIG. 22, the position that is located in the storage region A1 and from which the data to be processed is read is updated from the reading position P3(1) to a reading position P3(2). Subsequently, the longest matching data is searched based on data existing at the reading position P3(2).

FIG. 23 illustrates an example of a process of comparing data units different from data units forming data to be compressed. FIG. 23 illustrates a part of the storage region A1 and a part of the storage region A2. Data located at the reading position P3(2) is “10XXXXXX” and is data of the second byte or subsequent byte of a character code in the UTF-8 character set. For example, it is assumed that data that matches the data (“10XXXXXX”) located at the reading position P3(2) and is stored in the storage region A2 exists at a reference position P6(21) and a reference position P6(22), as illustrated in FIG. 23. In the example illustrated in FIG. 23, data located at the reference position P6(21) is data of the third byte of a 3-byte character code, and data located at the reference position P6(22) is data of the second byte of a 3-byte character code.

Data (“1110YYYY” in the example illustrated in FIG. 23) that succeeds the data located at the reading position P3(2), and data (“1110YYYY”) in the example illustrated in FIG. 23) that succeeds the data located at the reference position P6(21), are compared with each other in response to the match between the data located at the reading position P3(2) and the data located at the reference position P6(21). The data succeeding the data located at the reading position P3(2), and the data succeeding the data located at the reference position P6(21), are both data of the first bytes of 3-byte character codes in the comparing and are likely to match each other by the comparing.

The data (“1110YYYY” in the example illustrated in FIG. 23) that succeeds the data located at the reading position P3(2), and data (“10XXXXXX”) in the example illustrated in FIG. 23) that succeeds the data located at the reference position P6(22), are compared with each other in response to the match between the data located at the reading position P3(2) and the data located at the reference position P6(22). In this comparing, the data succeeding the data located at the reading position P3(2), and the data succeeding the data located at the reference position P6(22), are the data of the first byte of the 3-byte character code and data of the third byte of a 3-byte character code, respectively, and apparently do not match each other.

In each of the examples illustrated in FIGS. 22 and 23, by comparing 3-byte character codes on a byte basis, the longest matching data is segmented at a position different from a boundary between character codes. Thus, as illustrated in FIG. 23, data whose positions in character codes are different may be compared. However, the data of the first byte of the 3-byte character code and the data of the third byte of the 3-byte character code apparently do not match each other according to the character set, but are compared with each other.

On the other hand, in the embodiment, the comparing process is executed on a character code basis, and thus the execution of a process of comparing data items that are apparently different from each other is suppressed.

A modified example of the embodiment is described below. Not only the modified example is provided, but also design may be changed without departing from the gist of the embodiment.

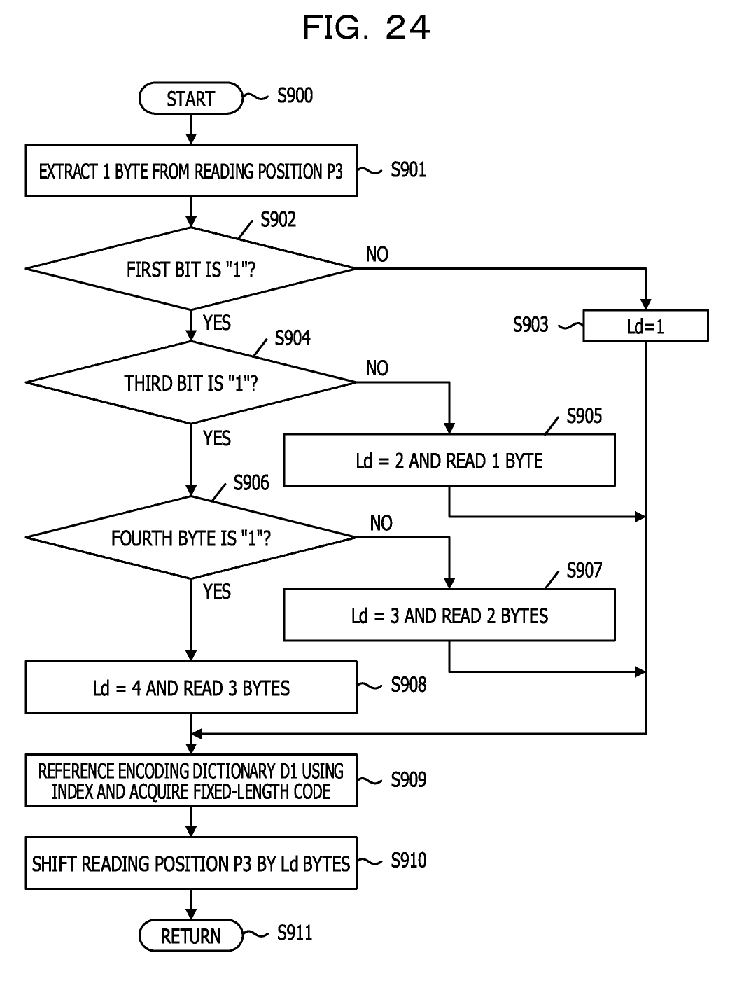

FIG. 24 illustrates an example of the processes of S301 to S303. The converter 114 executes the processes of S301 to S303 in accordance with the following procedure if character codes used in the file F1 are UTF-8 codes.

When S300 is executed (in S900), the converter 114 reads 1-byte data from the reading position P3 of the storage region A1 (in S901). The converter 114 determines whether or not the first bit of the read data is “1” (in S902). If the first bit of the data read in S901 is not “1” (or is “0”) (No in S902), the converter 114 substitutes 1 into a movement amount Ld (in S903). The movement amount Ld is used for update (described later) of the reading position P3.

If the first bit of the data read in S901 is “1” (Yes in S902), the converter 114 determines whether or not the third bit of the read data is “1” (in S904). If the third bit of the data read in S901 is not “1” (or is “0”) (No in S904), the converter 114 substitutes 2 into the movement amount Ld and reads 1-byte data from the storage region A1 (in S905).

If the third bit of the data read in S901 is “1” (Yes in S904), the converter 114 determines whether or not the fourth bit of the read data is “1” (in S906). If the fourth bit of the data read in S901 is not “1” (or is “0”) (No in S906), the converter 114 substitutes 3 into the movement amount Ld and reads 2-byte data from the storage region A1 (in S907).

If the fourth bit of the data read in S901 is “1” (Yes in S906), the converter 114 substitutes 4 into the movement amount Ld and reads 3-byte data from the storage region A1 (in S908).

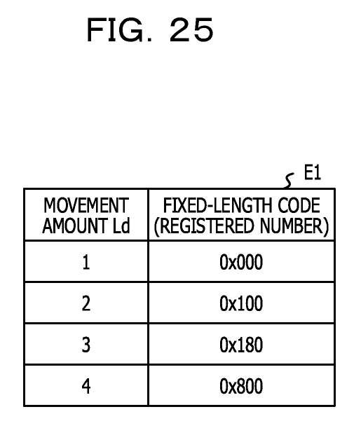

When any of S903, S905, S907, and S908 is executed, the converter 114 references an index E1 based on the movement amount Ld and uses the results of the reference to read a fixed-length code associated with the read data from the encoding dictionary D1 (in S909). The index E1 is described later with reference to FIG. 25. The converter 114 shifts the reading position P3 by the movement amount Ld (Ld bytes) (in S910). When the process of S910 is terminated, the converter 114 executes the process of S304.

FIG. 25 illustrates an example of the index of the encoding dictionary D1. The index E1 illustrated in FIG. 25 represents start positions of search within the encoding dictionary D1 in cases where the movement amount Ld is 1 to 4. For example, if the movement amount Ld is 1, the converter 114 starts the search within the encoding dictionary D1 from the position of a fixed-length code 0x000. If the movement amount Ld is 2, the converter 114 starts the search within the encoding dictionary D1 from the position of a fixed-length code 0x100. If the movement amount Ld is 3, the converter 114 starts the search within the encoding dictionary D1 from the position of a fixed-length code 0x180. If the movement amount Ld is 4, the converter 114 starts the search within the encoding dictionary D1 from the position of a fixed-length code 0x800. By setting values of the index E1 based on a distribution of the lengths of character codes included in the encoding dictionary D1, comparing of character codes having different lengths is suppressed. The encoding dictionary D2 may be searched using an index that is the same as or similar to the index illustrated in FIG. 25.

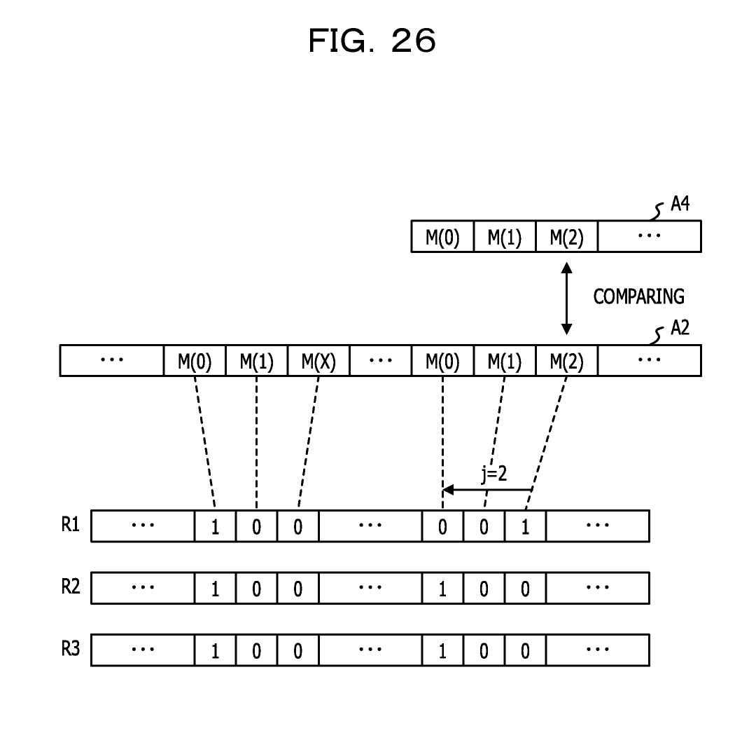

FIG. 26 illustrates a modified example of the process of searching the longest matching fixed-length code string. In the modified example illustrated in FIG. 26, bit strings R1 to R3 that include bits corresponding to the fixed-length codes within the storage region A2 are used. Regions for storing the bit strings R1 to R3 are included in the storage unit 13. Since one bit is used for each of the fixed-length codes within the storage region A2, the sizes of the bit strings are each 1/m of the storage region A2.

The bit string R1 represents whether or not the fixed-length code M(j) to be compared is included in the storage region A2. The fixed-length code M(j) is the fixed-length code stored at the j-th position within the storage region A4, as described above. If a fixed-length code that is the same as the fixed-length code M(j) is stored at a position Px in the storage region A2, a Px-th bit of the bit string R1 represents “presence” (or has a value of “1”).

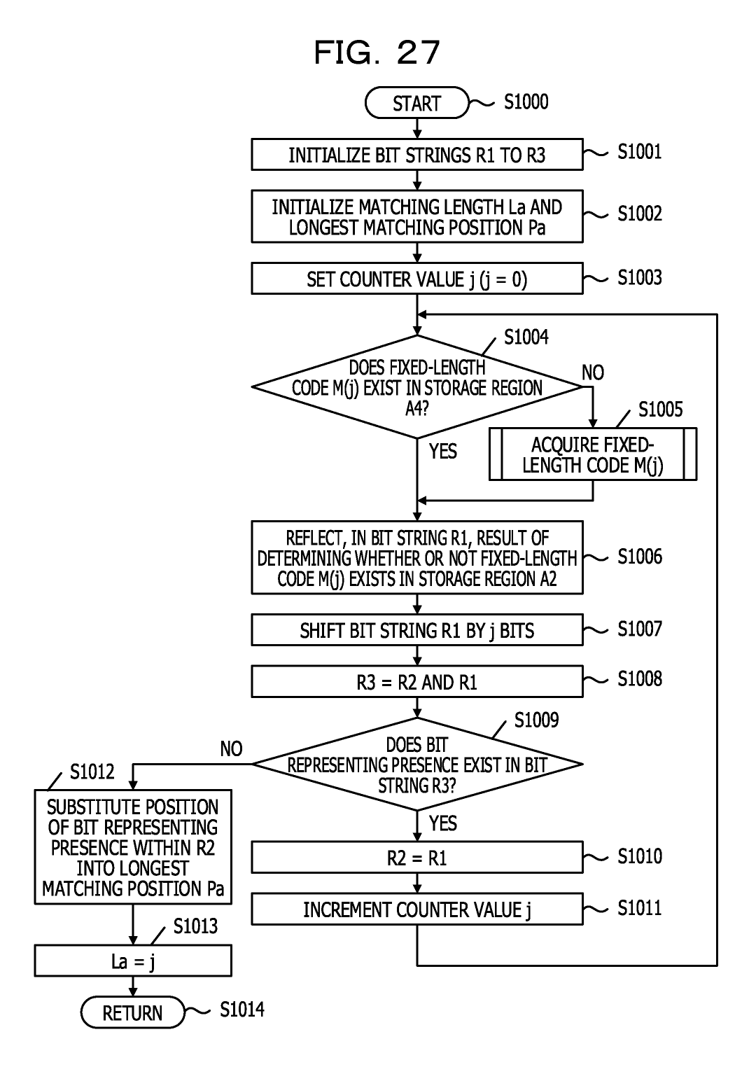

The bit string R2 represents the results of comparing fixed-length codes M(0) to M(j−1). In addition, the bit string R3 represents the results of calculating the bit strings R1 and R2. Specifically, the bit string R3 represents the results of an AND operation executed on the bit string R1 shifted by j bits (in a direction represented by an arrow in FIG. 26) and the bit string R2. After the AND operation is executed, the bit string R3 is copied into the bit string R2 for the process to be executed the j+i-th time. A specific procedure is described with reference to FIG. 27, but the longest matching position Pa is represented by a position at which a bit that represents “presence” remains until the end of the aforementioned process repeatedly executed using the bit strings R1 to R3. The number of times of the process repeatedly executed represents the matching length La.

FIG. 27 illustrates an example of the procedure for the process of searching the longest matching code string. When the process of searching the longest matching code string is started (in S1000), the controller 111 initializes the bit strings R1 to R3 (in S1001). Then, the controller 111 sets the matching length La and the longest matching position Pa to initial values (La=0 or the like, Pa=P4−1 or the like) (in S1002). In addition, the controller 111 sets the counter value j to the initial value (j=0) (in S1003).

Subsequently, the controller 111 determines whether or not the fixed-length code M(j) is stored in the storage region A4 (in S1004). If the fixed-length code M(j) is not stored in the storage region A4 (No in S1004), the controller 111 causes the converter 114 to execute a process of acquiring the fixed-length code M(j) (in S1005). The converter 114 executes the process illustrated in FIG. 12.

If the fixed-length code M(j) is stored in the storage region A4 (Yes in S1004) or when the process of S1005 is executed, the controller 111 reflects, in the bit string R1, the result of determining whether or not the fixed-length code M(j) exists in the storage region A2 (in S1006). For example, the controller 111 changes, to “1”, a bit corresponding to a position at which a fixed-length code that is the same as the fixed-length code M(j) stored in the storage region A2 exists. In addition, the controller 111 shifts the bit string R1 by j bits (in S1007), executes an AND operation on each bit of the bit string R2 and each bit of the bit string R1, and treats the results of the AND operation as the bit string R3 (in S1008).

Subsequently, the controller 111 determines whether or not a bit that represents presence (“1”) exists in the bit string R3 (in S1009). If the bit that represents presence (“1”) exists in the bit string R3 (Yes in S1009), the controller 111 copies the bit string R1 into the bit string R2 (in S1010), increments the counter value j (in S1011), and executes the process of S1004.

If the bit that represents presence (“1”) does not exist in the bit string R3 (No in S1009), the controller 111 substitutes the position (or a value representing the position of a bit) of any of bits included in the bit string R2 and representing presence (“1”) into the longest matching position Pa (or a value representing the number of fixed-length codes) (in S1012). In addition, the controller 111 substitutes the counter value j into the matching length La (in S1013). When the process of S1013 is executed, the controller 111 terminates the process of searching the longest matching code string (in S1014).

Another modified example of the embodiment is described, in which the execution of an unwanted comparing process due to the difference between the length of a character code and a data unit subjected to the comparing process is suppressed. For example, according to UTF-8, the length of a character code is determined based on data of the first byte of the character code. For example, in the process of S104 illustrated in FIG. 10, the comparing unit 112 may determine, based on 1-byte data located at the reading position P3 of the storage region A1 and 1-byte data located at the reference position P6 of the storage region A2, whether or not the lengths of character codes match each other. If the comparing unit 112 determines that the lengths of the character codes match each other, the comparing unit 112 may compare the character codes on a character code basis. The lengths of the character codes are determined based on the first bytes of the character codes. Thus, after the comparing unit 112 determines that the lengths of the character codes match each other, the comparing unit 112 reads the character codes located at the reading position P3 of the storage region A1 and the reference position P6 of the storage region A2 and compares the character codes on a character code basis.

If the length of the character code located at the reading position P3 of the storage region A1 does not match the length of the character code located at the reference position P6 of the storage region A2, the comparing process is skipped and the reference position P6 is updated. The amount of a movement of the reference position P6 due to the update of the reference position P6 is equal to the length of the character code located at the reference position P6, for example.

The modified example assumes that a character code is stored in the storage region A2. Specifically, a character code is written in the storage region A4 in the process of S304 illustrated in FIG. 12. Then, the character code within the storage region A4 is written in the storage region A2 in the process of S502 illustrated in FIG. 14. In addition, for example, the number of bytes of a determined character code is used as the movement amount Ld of the reading position P3.

As described above, if the number of bytes of a character code read from the reading position P3 of the storage region A1 does not match the number of bytes of a character code read from the reference position P6 of the storage region A2, unwanted comparing of the character codes is skipped and thereby avoid. If the modified example is used, a character code read from the storage region A1 is stored in the storage region A2 in the process of S106 illustrated in FIG. 10, as described above. In S708 illustrated in FIG. 17, decompressed data is written in the storage region B2, instead of a fixed-length code. In addition, the process of S706 is skipped.

In another modified example, the comparing unit 112 may execute the comparing process on a byte basis and determine whether or not data is located at the same positions within 1-byte character codes before comparing of 1-byte data. Data of bytes used to represent character codes is classified into multiple types based on the length of the character codes and positions within the character codes. The classification depends on the character codes. For example, as illustrated in FIG. 3, according to UTF-8, a 1-byte character is “0XXXXXXX”, the first byte of a 2-byte character is “110YYYYX”, the first byte of a 3-byte character is “1110YYYY”, the first byte of a 4-byte character is “11110YYY”, and the second and subsequent bytes of the 2- to 4-byte characters are “10XXXXXX”. “X” represents an unspecified bit. Specifically, according to UTF-8, data of bytes used to represent character codes is classified into five types based on data of several bits from the top bit of the data. It is apparent that 1-byte data of different multiple types is does not match even when the data is compared. Thus, the comparing unit 112 skips the comparing process if types of 1-byte data are different, for example. This suppresses unwanted comparing. In addition, since the types of the first bytes of character codes match each other, the longest matching data string is extracted by the process of comparing data of the character codes of which the lengths accordingly match each other. This modified example assumes that a character code is stored in the storage region A2. Thus, control that is the same as the previously described modified example is executed for the process of updating the storage region A2.

In addition, a monitoring message that is output from the system may be compressed in the compression process, instead of data within a file. For example, monitoring messages sequentially stored in a buffer are compressed by the aforementioned compression process, and a process of storing the monitoring messages as log files or the like is executed. In addition, for example, pages within a database may be compressed on a page basis or may be compressed on a multi-page basis.

In addition, data to be subjected to the aforementioned compression process is not limited to character information, as described above, and may be information of only numerical values. The compression process may be executed on data such as image data and audio data. For example, since a large number of the same data items are repeatedly arranged in data having a large amount and included in a file and obtained by voice synthesis, a compression rate is expected to be improved by a dynamic dictionary. In addition, since images of frames are similar in a video image acquired by a fixed camera, the same data is repeatedly, frequently arranged and included in the video image. Thus, effects that are the same as or similar to document data and audio data may be obtained by applying the aforementioned compression process to the video image.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method comprising:
acquiring a data string including a data group of which the sizes of constituent units of data are different sizes;
executing a comparing process, the comparing process comparing certain data included in the data group with data that is included in the data string and of which the sizes of constituent units are the same as the certain data;
extracting data matching the certain data from the data string based on the comparing process; and
generating, by a processor, a compressed code based on a relationship between a position of the certain data in the data string and a position of the extracted matching data in the data string.

2. The method according to claim 1, wherein
the comparing process compares fixed-length codes obtained by converting the certain data based on an encoding dictionary in which fixed-length codes are assigned to the data included in the data group, with fixed-length codes obtained by converting the data included in the data string based on the encoding dictionary.

3. The method according to claim 2, wherein
the comparing process is continuously executed in accordance with the order of the data string, and
the relationship is defined based on the position of a fixed-length code string based on continuously matching fixed-length codes that are the results of the continuously executed comparing process.

4. The method according to claim 3, wherein
the compressed code is generated based on the relationship and the length of the fixed-length code string.

5. The method according to claim 2, wherein
the encoding dictionary is generated based on the data group, and
the lengths of the fixed-length codes registered in the encoding dictionary are set based on the number of data groups.

6. The method according to claim 2, further comprising:
generating a compressed file including the generated compressed code and the encoding dictionary.

7. The method according to claim 1, further comprising:
suppressing the executing of the comparing process with regard to data when the positions of constituent units of the data to be subjected to the comparing process are different within the data.

8. The method according to claim 1, further comprising:
suppressing the executing of the comparing process with regard to data when the sizes of constituent units of the data to be subjected to the comparing process are different.

9. A method comprising:
acquiring a fixed-length code by referencing a storage region based on a compressed code representing a position within the storage region;
updating the storage region based on the acquired fixed-length code; and
decoding, by a processor, the acquired fixed-length code based on an encoding dictionary.

10. A system comprising:
a first memory; and
a first processor configured to execute a compression process including:
acquiring, from the first memory, a data string including a data group of which the sizes of constituent units of data are different sizes,
executing a comparing process, the comparing process comparing certain data included in the data group with data that is included in the data string and of which the sizes of constituent units are the same as the certain data,
extracting data matching the certain data from the data string based on the comparing process, and
generating a compressed code based on a relationship between a position of the certain data in the data string and a position of the extracted matching data in the data string.

11. The system according to claim 10, wherein
the comparing process compares fixed-length codes obtained by converting the certain data based on an encoding dictionary in which fixed-length codes are assigned to the data included in the data group, with fixed-length codes obtained by converting the data included in the data string based on the encoding dictionary.

12. The system according to claim 11, wherein
the comparing process is continuously executed in accordance with the order of the data string, and
the relationship is defined based on the position of a fixed-length code string based on continuously matching fixed-length codes that are the results of the continuously executed comparing process.

13. The system according to claim 12, wherein
the compressed code is generated based on the relationship and the length of the fixed-length code string.

14. The system according to claim 11, wherein
the encoding dictionary is generated based on the data group, and
the lengths of the fixed-length codes registered in the encoding dictionary are set based on the number of data groups.

15. The system according to claim 11, wherein the compression process includes:
generating a compressed file including the generated compressed code and the encoding dictionary.

16. The system according to claim 10, wherein the compression process includes:
suppressing the executing of the comparing process with regard to data when the sizes of constituent units of the data to be subjected to the comparing process are different.

17. The system according to claim 10, further comprising:
a second memory; and
a second processor configured to execute a decompression process including:
acquiring, from the second memory, a fixed-length code by referencing a storage region based on a compressed code representing a position within the storage region,
updating the storage region based on the acquired fixed-length code, and
decoding the acquired fixed-length code based on an encoding dictionary.
